(19) United States
(12) Patent Application Publication
(10) Pub. No.: US 2023/0097466 A1
(43) Pub. Date: Mar. 30, 2023

(54) WIRELESS COMMUNICATION SYSTEM AND WIRELESS CONNECTION METHOD

(71) Applicant: NIPPON TELEGRAPH AND TELEPHONE CORPORATION, Tokyo (JP)

(72) Inventors: Daisei UCHIDA, Musashino-shi, Tokyo (JP); Tatsuhiko IWAKUNI, Musashino-shi, Tokyo (JP); Chunhsiang HUANG, Musashino-shi, Tokyo (JP); Shuki WAI, Musashino-shi, Tokyo (JP); Naoki KITA, Musashino-shi, Tokyo (JP)

(73) Assignee: NIPPON TELEGRAPH AND TELEPHONE CORPORATION, Tokyo (JP)

(21) Appl. No.: 17/801,396

(22) PCT Filed: Feb. 26, 2020
(86) PCT No.: PCT/JP2020/007827

§ 371 Date: Aug. 22, 2022

(51) Int. Cl. H04W 36/08

(52) U.S. Cl. CPC H04W 36/08

(57) ABSTRACT

A plurality of ground station devices perform wireless communication processing for a side of a terminal station; and a single or a plurality of mobile station devices perform wireless communication processing for a side of a base station, so as to make a wireless connection in parallel with a plurality of the ground station devices having a line of sight.

A bridge device is connected with each of the plurality of ground station devices and a communication network and performs: obtaining connection configuration data indicating a connection configuration between each of the ground station devices and the mobile station devices from the ground station devices; transferring, upon receipt of from the communication network, data whose transmission destination is any of the mobile station devices, the received data to any of the ground station devices based on the obtained connection configuration data; and sending out, upon receipt of data from the ground station devices, the received data to the communication network.

### TECHNICAL FIELD

The present invention relates to a wireless communication system and a wireless connection method.

### BACKGROUND ART

With the spread of digital signage, public viewing, and Esports (electronic sports), technologies of 4k/8k video and augmented reality (AR)/virtual reality (VR) are increasingly used and accordingly, a need for high-volume stream transfer has become apparent. In addition, with the spread of artificial intelligence (AI) analysis using big data and autonomous driving of vehicles, a need for high-volume data transfer for transferring storage data such as map data, video data, sensor data, or the like has also become apparent.

Furthermore, recently, the range of terminal devices to be targeted for high-volume stream transfer and data transfer is not limited only to fixed terminal devices used for signage displays, public viewing displays and the like, but has expanded to portable terminal devices such as a smartphone and a tablet and to mobile terminal devices such as for moving bodies such as cars and trains. Therefore, there is a desire to implement high-volume, high-speed wireless communication allowing such high-volume transfer also to the portable terminal devices and the mobile terminal devices. As means for implementing such high-volume, high-speed wireless communication, wireless communication means that utilizes a high frequency band such as a quasi-millimeter wave band or millimeter wave band, which is used in 5th generation (5G) and Wireless Gigabit (WiGig), is said to be promising.

As the high frequency band, for example, in 60 GHz band used by WiGig, a wide band of approximately 9 GHz is available in many countries; and 1 gigabit per second (Gbps) or higher gigabit wireless can be implemented also in a modulation/demodulation scheme that operates even in a low carrier-to-noise ratio (CNR) environment, such as binary phase shift keying (BPSK) and quadrature phase shift keying (QPSK). Therefore, if a line of sight can be secured, a stable gigabit wireless transfer is possible.

However, unlike a low frequency band that is equal to or lower than a microwave band, a diffraction loss in a high frequency band is large. Therefore, in a non-line-of-sight environment where obstructions such as people and buildings exist in a radio wave propagation path from a transmission side to a reception side and thereby, a line of sight is lost, radio waves do not reach the reception side. As measures taken in using a high frequency band in such a non-line-of-sight environment, it is common to use a technique in which a plurality of ground station devices are installed at different locations on a ground side so as to allow a plurality of radio propagation paths to be established between a mobile station device and the plurality of ground station devices, and a radio transmission is maintained using any of the radio propagation paths that has a line of sight.

### CITATION LIST

### Non-Patent Literature

Non-Patent Literature 1: Fumiyuki Adachi, Amnart Boonkajay, Tomoyuki Saito, Yuta Seki, “Distributed MIMO Cooperative Transmission Technique and Its Performance,” IEICE Tech. Rep., The Institute of Electronics, Information and Communication Engineers, RCS2018-326, 2019-03, pp. 225-230

### SUMMARY OF THE INVENTION

### Technical Problem

(Technique of a Wireless Connection Through Handover)

As one technique for maintaining a radio transmission in a high frequency band, a technique of wireless connection through handover has been provided. In the handover technique, a mobile station device selects and wirelessly connects to any of a plurality of ground station devices. Assume that in accordance with movement of the mobile station device, a radio propagation path for the current wireless connection enters a non-line-of-sight environment and deterioration on a radio transmission quality or disconnection occurs. In this case, the mobile station device searches for and detects another ground station device that has a line-of-sight; and wirelessly connects to the detected ground station device, thereby maintaining a radio transmission.

FIG. 17 is a block diagram illustrating a configuration of a wireless communication system 600 in the case of using the handover technique. The wireless communication system 600 includes a mobile station device 100, three ground station devices 200-1, 200-2, and 200-3, and a communication network 300. Note that although FIG. 17 illustrates the three ground station devices 200-1 to 200-3 as one example, any number of units is acceptable as long as there are a plurality of units.

The mobile station device 100 includes a terminal station wireless communication processing unit 102 and a mobile station antenna 101 that is connected to the terminal station wireless communication processing unit 102. Each of the ground station devices 200-1 to 200-3 has the same configuration; and each includes a base station wireless communication processing unit 202-1, 202-2, or 202-3 and a ground station antenna 201-1, 201-2, or 201-3 that is connected to its corresponding base station wireless communication processing unit 202-1 to 202-3. In addition, each of the ground station devices 200-1 to 200-3 is connected to the communication network 300.

How a wireless connection through handover is made in a case where there are two obstructions 900 and 901 in the wireless communication system 600 will be described in accordance with a movement scenario in which the location of the mobile station device 100 changes, more specifically, with six cases from case 1 to case 6.

The mobile station device 100 wirelessly connects to any one of the ground station devices 200-1 to 200-3; and, when the wireless connection is broken, searches for and detects another ground station device 200-1 to 200-3 and makes a reconnection.

For example, assume that the mobile station device 100 is being connected by radio to the ground station device 200-1 in a location relation of the case 1. After that, when the mobile station device 100 moves and a location relation of the case 2 is established, a radio propagation path with the ground station device 200-1 is obstructed by the obstruction 900 and the wireless connection is broken. When the wireless connection with the ground station device 200-1 is broken, the mobile station device 100 searches for another ground station device 200-2 or 200-3 in the vicinity.

After that, when the mobile station device 100 moves and a location relation of the case 3 is established, the mobile station device 100 searches for and detects the ground station device 200-2, and makes a reconnection to the detected ground station device 200-2. During a period from the case 3 to the case 4, the line of sight with the ground station device 200-2 is maintained. Therefore, the mobile station device 100 maintains a wireless connection with the ground station device 200-2.

After that, when the mobile station device 100 moves and a location relation of the case 5 is established, a radio propagation path with the ground station device 200-2 is obstructed by the obstruction 901 and the wireless connection is broken again. When the wireless connection with the ground station device 200-2 is broken, the mobile station device 100 attempts to detect another ground station device 200-1 or 200-3 in the vicinity, as with the case 2. When the mobile station device 100 moves and a location relation of the case 6 is established, the mobile station device 100 detects the ground station device 200-3, and makes a reconnection. Note that the location relation between the mobile station device 100, the obstructions 900 and 901, and the ground station devices 200-1 to 200-3 in the above cases 1 to 6 is one example and in other similar location relations, the same wireless connection processing by the handover technique is performed.

In the case of the handover technique, there is a problem that a wireless connection is once broken during a period between when wireless connection with a ground station device 200-1 to 200-3 of a connection destination is broken and when the mobile station device 100 detects another ground station device 200-1 to 200-3, for example in the above, during periods between the case 2 and the case 3, and between the case 5 and the case 6.

When a frequency band is a millimeter wave or higher frequency band, the wave length of radio waves is 1 cm or less and therefore, propagation of the radio waves is obstructed even by obstructions of several ten cm such as a utility pole, tree, or person. If handover is performed under such an environment, it becomes necessary to switch between the ground station devices 200-1 to 200-3 of wireless connection destinations by a movement distance of several ten cm. Here, for example, when the mobile station device 100 is moving at a speed of 36 km/h, the movement distance of 10 cm corresponds to 10 msec and several ten cm corresponds to several ten msec.

In a common handover technique, it is necessary to perform three processes: a process of detecting deterioration of a radio transmission quality and a disconnection; a process of searching for another ground station device 200-1 to 200-3; and a process of wireless connection with the other ground station device 200-1 to 200-3. In the case of moving at a speed of 36 km/h, when these three processes cannot be completed within several ten msec, switching to wireless connection with another ground station device 200-1 to 200-3 having a line of sight is impossible. In other words, when a line-of-sight environment changes in such a short period of time, the handover causes a problem in which it is difficult to maintain a wireless connection with a ground station device 200-1 to 200-3 having a line of sight.

(Technique of a Wireless Connection Through Site Diversity)

There is a wireless connection technique called site diversity in which one ground station includes a plurality of antenna and a mobile station device performs a radio transmission with the plurality of antennas in parallel (for example, see Non-Patent Literature 1). The site diversity technique includes: a synthetic site diversity in which the same radio signal is transmitted in parallel from a plurality of antennas and the same radio signal is received in parallel; and a selective site diversity in which these antenna are speedily switched in a physical layer range.

FIG. 18 is a block diagram illustrating a configuration of a wireless communication system 700 in the case of using the site diversity technique. The wireless communication system 700 includes a mobile station device 400, a ground station devices 500, and a communication network 300. The mobile station device 400 includes a terminal station wireless communication processing unit 402 and a mobile station antenna 401 that is connected to the terminal station wireless communication processing unit 402.

The ground station device 500 includes: three base station radio units 502-1 to 502-3; three ground station antennas 501-1 to 501-3 that are connected to the three base station radio units 502-1 to 502-3, respectively; and a base station signal processing unit 503 that is connected to the three base station radio units 502-1 to 502-3. The communication unit 300 is connected to the base station signal processing unit 503. Note that although FIG. 18 illustrates the three base station radio units 502-1 to 502-3 as one example, any number of units is acceptable as long as there are a plurality of units and the number of ground station antennas 501-1 to 501-3 to be provided corresponds to the number of base station radio units 502-1 to 502-3.

In addition, the sharing of processing between the base station radio units 502-1 to 502-3 and the base station signal processing unit 503 is such that the base station radio units 502-1 to 502-3 perform radio frequency (RF) processing and the base station signal processing unit 503 performs signal processing. However, if it is possible to decode radio signals received by the ground station antennas 501-1 to 501-3 and aggregate at one location and to transmit the signals modulated at the one location from the ground station antennas 501-1 to 501-3, the sharing of processing is freely determined; and the base station radio units 502-1 to 502-3 may perform partial signal processing that is to be performed by the base station signal processing unit 503 and this signal processing may be omitted from the signal processing that is to be performed by the base station signal processing unit 503.

Each of the ground station antennas 501-1 to 501-3 is remotely installed as measures to be taken in a non-line-of-sight environment produced due to the obstructions 900 and 901. The ground station antennas 501-1 to 501-3 are connected to the same base station signal processing unit 503 via the base station radio units 502-1 to 502-3. Therefore, all of the base station radio units 502-1 to 502-3 receive a radio signal transmitted by the mobile station device 400 and parallelly transmit a radio signal to the mobile station device 400, through the ground station antennas 501-1 to 501-3 respectively connected thereto.

How wireless connection through the site diversity is made in a case where there are two obstructions 900 and 901 in the wireless communication system 700 as with the wireless communication system 600 illustrated in FIG. 17 will be described in accordance with a movement scenario in which the location of the mobile station device 400 changes, more specifically, with six cases from case 1 to case 6.

In the location relation in the case 1, the mobile station device 400 wirelessly connects to the base station radio unit 502-1 via the ground station antenna 501-1; and transmits and receive a radio signal. In the case 1, radio waves do not reach the ground station antennas 501-2 and 501-3 due to the obstruction 900 and therefore, there is no wireless connection with the base station radio units 502-2 and 502-3.

When the mobile station device 400 moves and a location relation of the case 2 is established, a line of sight from the mobile station device 400 to the ground station antenna 501-1 is lost due to the obstruction 900 and therefore, radio propagation in the high frequency band is obstructed and wireless connection is broken. However, when the location relation of the case 2 is established, a line of sight from the mobile station device 400 to the ground station antenna 501-2 is obtained; and therefore, the mobile station device 400 wirelessly connects to the base station radio unit 502-2 via the ground station antenna 501-2 and transmits and receive a radio signal.

In a process of transition from the case 1 to the case 2, if the mobile station device 400 can obtain a line of sight to the ground station antenna 501-2 before a wireless connection with the base station radio unit 502-1 is broken, the mobile station device 400 wirelessly connects to both the base station radio unit 502-1 and the base station radio unit 502-2 and the mobile station device 400 can maintain a wireless connection with any of the base station radio units 502-1 and 502-2.

After that, the location relation between the mobile station device 400 and the ground station device 500 changes to the cases 3 and 4, and the line of sight with the ground station antenna 501-2 is maintained during a period from the case 3 to the case 4. Therefore, the mobile station device 400 maintains a wireless connection with the base station radio unit 502-2. In the location relation of the cases 5 and 6, the mobile station device 400 loses a wireless connection with the base station radio unit 502-2 and wirelessly connects to the base station radio unit 502-3 via the ground station antenna 501-3.

Also in the case 5, as with the case 2, if a line of sight to the ground station antenna 501-3 is obtained before a wireless connection with the base station radio unit 502-2 is broken, the mobile station device 400 wirelessly connects to both the base station radio unit 502-2 and the base station radio unit 502-3. Note that the location relation between the mobile station device 400, the obstructions 900 and 901, and the ground station antennas 501-1 to 501-3 in the above cases 1 to 6 is one example and in a similar location relation, the same wireless connection processing by the site diversity technique is performed.

In the site diversity technique, both the base station radio units 502-1 to 502-3 that are connected to the plurality of ground station antennas 501-1 to 501-3, respectively which are installed at remote locations of the ground station device 500 and the mobile station device 400 can parallelly transmit and receive a radio signal. Therefore, even if the mobile station device 400 moves to any location, a wireless connection can be maintained as long as a line of sight with the ground station antenna 501-1 to 501-3 is secured.

However, in the site diversity technique, it is limited only to a case in which the ground station device 500 includes the function of site diversity. For example, in mobile communication cellular Long Term Evolution (LTE) and 5G, the function of site diversity is a standardized function and a wireless communication device including the function of site diversity actually exists. Therefore, if such a wireless communication device can be used, the site diversity technique is effective as measures to be taken in using a high frequency band in a non-line-of-sight environment.

However, for example, in IEEE802.11ad based on which wireless communication is performed in a higher frequency band of 60 GHz band, the function of site diversity is not a standardized function. Therefore, in a high frequency band, the site diversity technique cannot be used in some standards. Thus, under a situation where a line-of-sight environment changes, it is difficult to continue to maintain a wireless connection.

In view of the above circumstance, an object of the present invention is to provide a technique that allows a radio transmission to be maintained even if a line-of-sight environment changes in a wireless communication scheme using a high frequency band.

### Means for Solving the Problem

One aspect of the present invention is a wireless communication system that includes: a plurality of ground station devices each of which includes a terminal station wireless communication processing unit that performs wireless communication processing for a side of a terminal station; a single or a plurality of mobile station devices each of which includes a base station wireless communication processing unit that performs wireless communication processing for a side of a base station making a wireless connection in parallel with the terminal station and makes a wireless connection in parallel with a plurality of the ground station devices having a line of sight; and a bridge device that is connected with each of a plurality of the ground station devices and a communication network and is configured to obtain connection configuration data indicating a connection configuration between each of the ground station devices and the mobile station devices from the ground station devices, transfer, upon receipt of data whose transmission destination is any of the mobile station devices from the communication network, the received data to any of the ground station devices based on the obtained connection configuration data, and send out, upon receipt of data from the ground station devices, the received data to the communication network.

One aspect of the present invention is a wireless connection method that includes: causing a plurality of ground station devices to perform wireless communication processing for a side of a terminal station; causing a single or a plurality of mobile station devices to perform wireless communication processing for a side of a base station that makes a wireless connection in parallel with the terminal station, so as to make a wireless connection in parallel with a plurality of the ground station devices having a line of sight; and causing a bridge device to be connected with each of a plurality of the ground station devices and a communication network and to perform: obtaining connection configuration data indicating a connection configuration between each of the ground station devices and the mobile station devices from the ground station devices: transferring, upon receipt of data whose transmission destination is any of the mobile station devices from the communication network, the received data to any of the ground station devices based on the obtained connection configuration data; and sending out, upon receipt of data from the ground station devices, the received data to the communication network.

### Effects of the Invention

According to the present invention, a radio transmission can be maintained even if a line-of-sight environment changes in a wireless communication scheme using a high frequency band.

### BRIEF DESCRIPTION OF DRAWINGS

FIG. 1 is a block diagram illustrating a configuration of a wireless communication system of a first embodiment.

FIG. 2 is a diagram illustrating a transition of a wireless connection state in the first embodiment.

FIG. 3 is a block diagram illustrating a configuration of a wireless communication system of a second embodiment.

FIG. 4 is a flowchart illustrating processing by a switching instruction device of to the second embodiment.

FIG. 5 is a diagram illustrating a transition of a wireless connection state in the second embodiment.

FIG. 6 is a block diagram illustrating a configuration of a wireless communication system of a third embodiment.

FIG. 7 is a flowchart illustrating processing by a switching instruction device of the third embodiment.

FIG. 8 is a block diagram illustrating another configuration example of the third embodiment.

FIG. 9 is a block diagram illustrating a configuration of a wireless communication system of a fourth embodiment.

FIG. 10 is a flowchart illustrating processing by a switching instruction device of the fourth embodiment.

FIG. 11 is a block diagram illustrating a configuration of a wireless communication system of a fifth embodiment.

FIG. 12 is a flowchart illustrating processing by a switching instruction device of the fifth embodiment.

FIG. 13 is a block diagram illustrating a configuration of a wireless communication system of a sixth embodiment.

FIG. 14 is a flowchart illustrating processing by a switching instruction device of the sixth embodiment.

FIG. 15 is a block diagram illustrating a configuration of a wireless communication system of a seventh embodiment.

FIG. 16 is a flowchart illustrating processing by a switching instruction device of the seventh embodiment.

FIG. 17 is a diagram illustrating a transition of a wireless connection state by a handover technique.

FIG. 18 is a diagram illustrating a transition of a wireless connection state by a site diversity technique.

### DESCRIPTION OF EMBODIMENTS

### First Embodiment

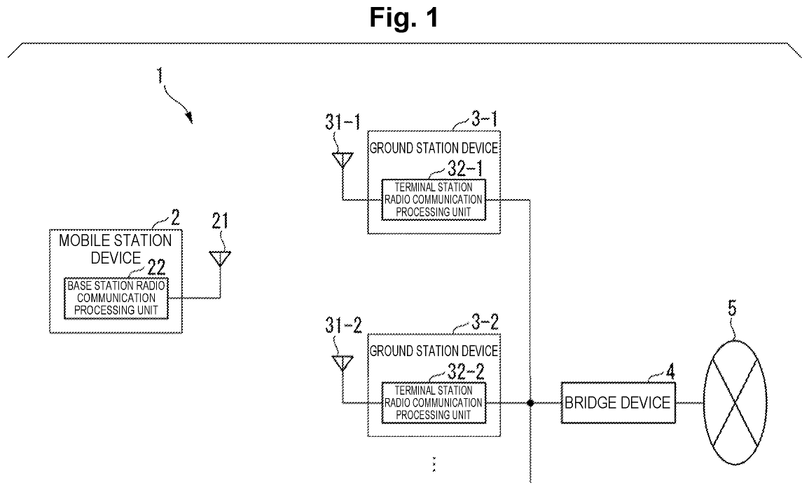

Hereinafter, an embodiment of the present invention will be described with reference to drawings. FIG. 1 is a block diagram illustrating a configuration of a wireless communication system 1 of a first embodiment. The wireless communication system 1 includes a mobile station device 2, a plurality of ground station devices 3-1, 3-2, . . . , a bridge device 4, and a communication network 5. The mobile station device 2 is a device that is allowed to move by being carried by a person or mounted on a vehicle. The mobile station device 2 includes a mobile station antenna 21 and a base station wireless communication processing unit 22. The mobile station antenna 21 is connected to the base station wireless communication processing unit 22 and radiates radio waves into the air.

The base station wireless communication processing unit 22 captures data to be transmitted, modulates the data to generate a radio signal, and transmits the radio signal in a high frequency band through the mobile station antenna 21. The high frequency band in this embodiment is, for example, a frequency band from 20 GHz to 3 THz including a quasi-millimeter wave band (20 to 30 GHz band), a millimeter wave band (30 to 300 GHz), and a submillimeter wave band (300 GHz to 3 THz). The high frequency band may be a frequency band of a quasi-millimeter wave band, a frequency band of a millimeter wave band, a frequency band of a submillimeter wave band, a frequency band including both a quasi-millimeter wave band and a millimeter wave band, or a frequency band including a millimeter wave band, and a submillimeter wave band. In addition, the base station wireless communication processing unit 22 receives a radio signal in a high frequency band through the mobile station antenna 21 and demodulate the received radio signal to restore data.

The ground station devices 3-1, 3-2, . . . are fixedly installed devices whose locations do not change. Each of the ground station devices 3-1, 3-2, . . . has the same configuration; and each includes a ground station antenna 31-1, 31-2, . . . and a terminal station wireless communication processing unit 32-1, 32-2, . . . . Each of the ground station antennas 31-1, 31-2, . . . is connected to the terminal station wireless communication processing unit 32-1, 32-2, . . . and radiate radio waves into the air.

Each of the terminal station wireless communication processing units 32-1, 32-2, . . . captures data to be transmitted, modulates the data to generate a radio signal, and transmits the radio signal in a high frequency band through each correspondingly connected ground station antenna 31-1, 31-2, . . . . In addition, each of the terminal station wireless communication processing units 32-1, 32-2, . . . receives a radio signal in a high frequency band through each correspondingly connected ground station antenna 31-1, 31-2, . . . , and demodulate the received radio signal to restore data.

In the wireless communication system 1, the mobile station device 2 has a configuration of a base station wireless communication device in a wireless communication scheme such as IEEE 802.11ad, that is, a configuration of performing processing for a parallel wireless connection to a plurality of terminal station wireless communication devices. In addition, the ground station devices 3-1, 3-2, . . . have a configuration of a terminal station wireless communication device, that is, a configuration of performing processing for: wirelessly connecting only to a wireless communication device of one base station and, when the wireless connection with the base station is broken, wirelessly connecting to another base station which can be connected by radio. Therefore, in the wireless communication system 1, the mobile station device 2 is allowed to perform a parallel wireless connection to the plurality of ground station devices 3-1, 3-2, . . . and to have a plurality of radio propagation paths.

The bridge device 4 has a plurality of ports and transfers data which has been captured from a port, to another port according to a transmission destination. In the first embodiment, the ground station devices 3-1, 3-2, . . . and the communication network 5 are connected to the bridge device 4.

The terminal station wireless communication processing units 32-1, 32-2, . . . included in the ground station devices 3-1, 3-2, . . . do not include a bridge configuration for performing transmission and reception of data to and from the communication network 5, which are performed by a common base-station-side wireless communication device. The bridge device 4 is provided for the purpose of adding this bridge configuration. Therefore, the bridge device 4 performs processing for movement management that is included in a common base-station-side wireless communication device, that is, processing of collecting connection configuration data indicating a connection configuration that indicates which of the ground station devices 3-1, 3-2, . . . the mobile station device 2 is being connected to. The bridge device 4 transfers, when capturing data whose transmission destination is the mobile station device 2, the captured data to a terminal station wireless communication processing unit 32-1, 32-2, . . . that is being connected to the mobile station device 2 according to the collected connection configuration data.

The processing of collecting connection configuration data is performed, for example, by the bridge device 4 capturing the connection configuration data that indicates a connection configuration with the mobile station device 2, which is notified at a fixed time interval by each of the terminal station wireless communication processing units 32-1, 32-2, . . . that are included in the ground station devices 3-1, 3-2, . . . .

In addition, when detecting from the connection configuration data that the mobile station device 2 is being connected by radio with a plurality of ground station devices 3-1, 3-2, . . . , the bridge device 4 transfers data received from the communication network 5, to all the ground station devices 3-1, 3-2, . . . which are being connected by radio; or transfers data received from the communication network 5, to any one of the ground station devices 3-1, 3-2, . . . .

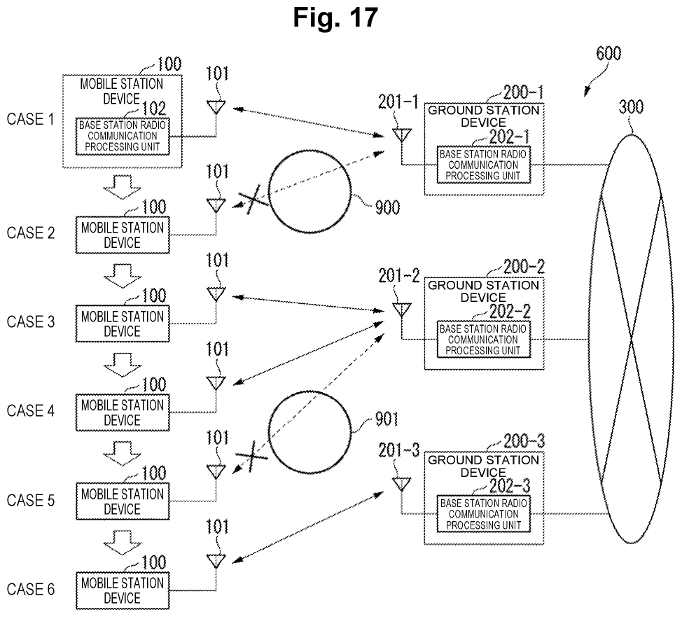

Each of the ground station devices 3-1, 3-2, . . . including the terminal station wireless communication processing unit 32-1, 32-2, . . . searches for a mobile station device 2 in the vicinity and when performing a wireless connection with the mobile station device 2 detected by search, maintains the wireless connection with the mobile station device 2 for a period until a radio quality deteriorates or the wireless connection is broken. In other words, the handover technique performed in the wireless communication system 600 illustrated in FIG. 17 is performed between the ground station devices 3-1, 3-2, . . . and the mobile station device 2 with their roles swapped therebetween.

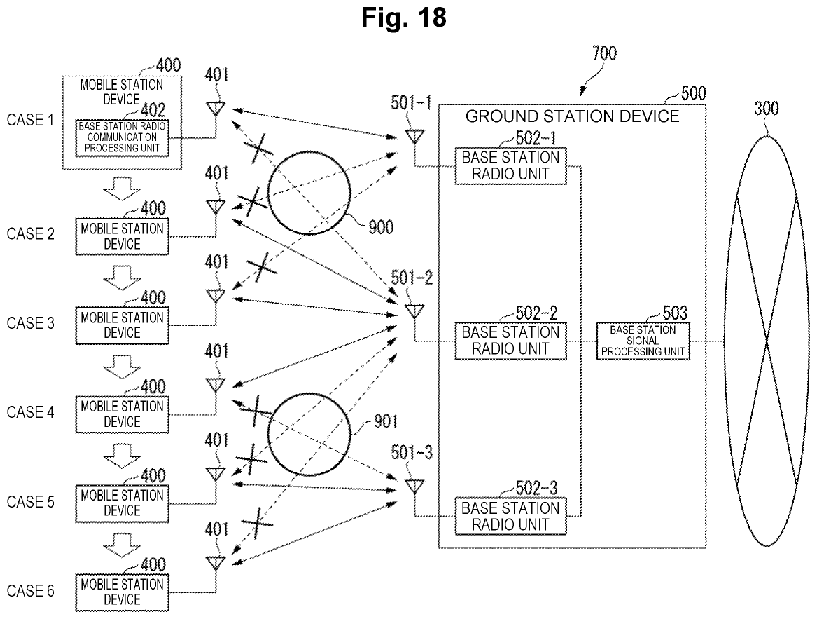

In the wireless communication system 1, only the mobile station device 2 includes the base station wireless communication processing unit 22. Therefore, if a line of sight with the mobile station device 2 is obtained and a wireless connection is possible, the plurality of ground station devices 3-1, 3-1, . . . perform a wireless connection to the mobile station device 2. This causes wireless connection processing between the mobile station device 2 and the ground station devices 3-1, 3-2, . . . , which is equivalent to the site diversity technique described using the wireless communication system 700 illustrated in FIG. 18, to be performed between the mobile station device 2 and the ground station devices 3-1, 3-2,

(Wireless Connection Processing by the Wireless Communication System of the First Embodiment)

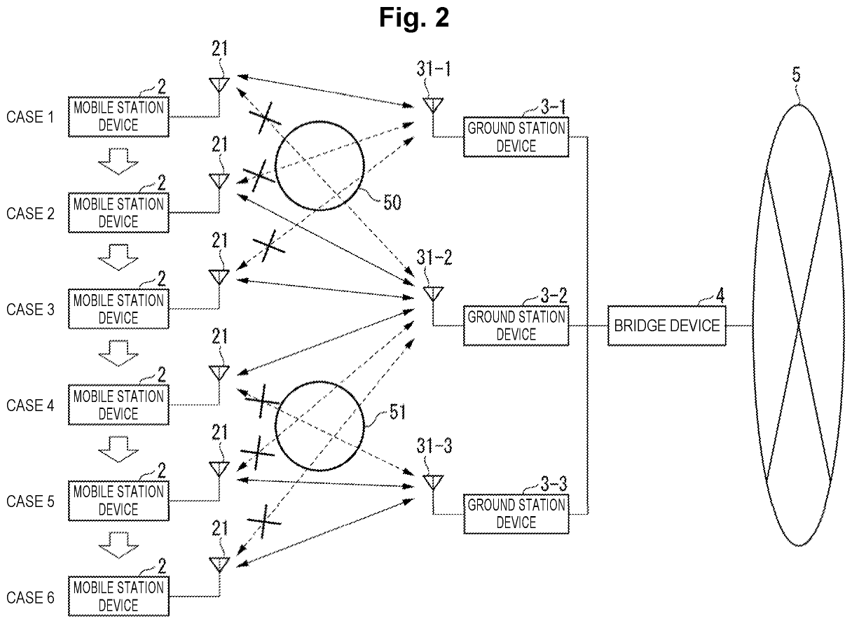

Next, wireless connection processing in the wireless communication system 1 of the first embodiment will be described with reference to FIG. 2. FIG. 2 is a diagram illustrating how a wireless connection is performed between the mobile station device 2 and the ground station devices 3-1, 3-2, and 3-3 in a case where two obstructions 50 and 51 exist in the wireless communication system 1, with a movement scenario in which the location of the mobile station device 2 changes, more specifically, with six divided cases of case 1 to case 6. Note that in FIG. 2, the number of ground station devices 3-1, 3-2, . . . included in the wireless communication system 1 is three for convenience of description.

In the location relation of the case 1, the mobile station device 2 is connected by radio with the ground station device 3-1, and is not connected by radio with the ground station devices 3-2 and 3-3 since radio waves do not reach them due to the obstruction 50.

When the mobile station device 2 moves and a location relation of the case 2 is established, a line of sight from the mobile station device 2 to the ground station device 3-1 is lost due to the obstruction 50 and therefore, radio propagation in a high frequency band is obstructed and wireless connection is broken. However, when the location relation in the case 2 is established, a line of sight from the mobile station device 2 to the ground station device 3-2 is obtained; and therefore, the mobile station device 2 wirelessly connects to the ground station device 3-2 and transmits and receive a radio signal.

In a process of transition from the case 1 to the case 2, if the mobile station device 2 obtains a line of sight to the ground station device 3-2 before a wireless connection with the ground station device 3-1 is broken, the mobile station device 2 wirelessly connects to both the ground station device 3-1 and the ground station device 3-2 and the mobile station device 2 can maintain a wireless connection with any of the ground station devices 3-1 and 3-2.

After that, the location relation between the mobile station device 2 and the ground station devices 3-1, 3-2, and 3-3 changes to cases 3 and 4, and a line of sight with the ground station device 3-2 is maintained during a period from the case 3 to the case 4. Therefore, the mobile station device 2 maintains a wireless connection with the ground station device 3-2. In the location relation in the cases 5 and 6, the mobile station device 2 loses a wireless connection with the ground station device 3-2 and wirelessly connects to the ground station device 3-3.

Also in the case 5, as with the case 2, if a line of sight to the ground station device 3-3 is obtained before a wireless connection with the ground station device 3-2 is broken, the mobile station device 2 wirelessly connects to both the ground station device 3-2 and the ground station device 3-3. Note that the location relation between the mobile station device 2, the obstructions 50 and 51, and the ground station devices 3-1 to 3-3 in the above cases 1 to 6 is one example and in a similar location relation, the same wireless connection processing is performed.

In the wireless communication system 1 of the first embodiment described above, the plurality of ground station devices 3-1, 3-2, . . . include the terminal station wireless communication processing units 32-1, 32-2, . . . , respectively. The terminal station wireless communication processing units 32-1, 32-2, . . . perform wireless communication processing for a terminal station side. The single or plurality of the mobile station devices 2 includes the base station wireless communication processing unit 22. The base station wireless communication processing unit 22 performs wireless communication processing for a base station side and performs a wireless connection in parallel with a plurality of ground station devices 3-1, 3-2, . . . having a line of sight. The bridge device 4 is connected with each of the plurality of ground station devices 3-1, 3-2, . . . and the communication network 5. The bridge device 4 obtains, from the ground station devices 3-1, 3-2, . . . , connection configuration data indicating a connection configuration between each of the ground station devices 3-1, 3-2, . . . and the mobile station devices 2. The bridge device 4 transfers, upon receipt of data whose transmission destination is any of the mobile station devices 2 from the communication network 5, the received data to any of the ground station devices 3-1, 3-2, . . . based on the obtained connection configuration data. The bridge device 4 sends out, upon receipt of data from the ground station devices 3-1, 3-2, . . . , the received data to the communication network 5.

More specifically, in the wireless communication system 1, roles of the base station and the terminal station are swapped with each other: the mobile station device 2 performs processing that is to be performed by a wireless communication device of the base station and the ground station devices 3-1 to 3-3 perform processing that is to be performed by a wireless communication device of the terminal station. This makes it possible to perform processing equivalent to wireless connection processing through site diversity by the wireless communication system 700 which is illustrated in FIG. 18. Consequently, the problem of being incapable of maintaining a wireless connection can be avoided which may occur in switching a wireless connection in a short period of time for performing handover in a high frequency band.

Therefore, even when the mobile station device 2 and the ground station devices 3-1, 3-2, . . . use a high frequency band and do not include a configuration for wireless connection processing through site diversity, for example, they are wireless communication devices based on the IEEE 802.11ad standard, wireless connection processing equivalent to site diversity can be performed. In addition, even in an environment in which the obstructions 50 and 51 obstructing radio waves exist and a line of sight changes, a wireless connection can be maintained as long as a line of sight can be secured between the mobile station device 2 and any of the ground station devices 3-1, 3-2,

### Second Embodiment

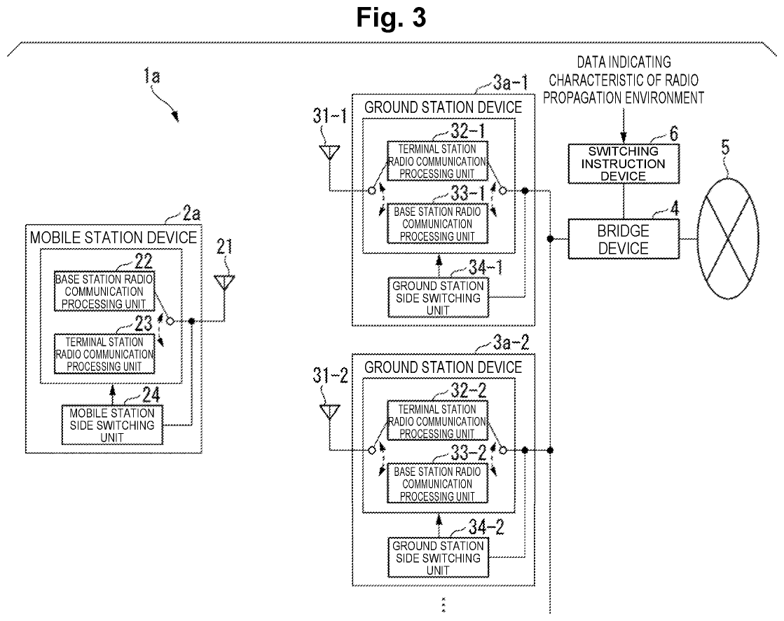

FIG. 3 is a block diagram illustrating a configuration of a wireless communication system 1a according to a second embodiment. As for the wireless communication system 1a, the same components as those of the wireless communication system 1 are denoted by the same reference signs and different components will be described below. The wireless communication system 1a includes a mobile station device 2, a plurality of ground station devices 3-1a, 3-2a, . . . , a bridge device 4, a communication network 5, and a switching instruction device 6. In the second embodiment, the ground station devices 3a-1, 3a-2, . . . , the communication network 5, and the switching instruction device 6 are connected to the bridge device 4.

In the wireless communication system 1a, a relationship of a base station and a terminal station between the mobile station device 2a and the ground station devices 3a-1, 3a-2, . . . is switched based on data indicating the characteristic of a radio propagation environment. More specifically, in an environment in which wireless connection processing equivalent to site diversity which is described in the first embodiment is necessary, the wireless connection processing is performed where the mobile station device 2a is a base station wireless communication device and the ground station devices 3a-1, 3a-2, . . . are terminal station wireless communication devices. On the other hand, in an environment in which wireless connection processing equivalent to site diversity is not necessary, that is, in an environment in which wireless connection processing through handover suffices, the mobile station device 2a is a terminal station wireless communication device and the ground station devices 3a-1, 3a-2, . . . are base station wireless communication devices, as with the wireless communication system 600 illustrated in FIG. 17.

The environment in which wireless connection processing equivalent to site diversity is necessary is, for example, an environment in which several obstructions exist and the mobile station device 2a moves, causing a line of sight between the mobile station device 2a and the ground station devices 3a-1, 3a-2, . . . to change. On the other hand, the environment in which wireless connection processing through handover suffices is, for example, an environment in which the mobile station device 2a is standing still.

In the wireless communication system 1a, the mobile station device 2a is a device that is allowed to move by being carried by a person or mounted on a vehicle, as with the mobile station device 2 of the first embodiment. The mobile station device 2a includes a mobile station antenna 21, a base station wireless communication processing unit 22, a terminal station wireless communication processing unit 23, and a mobile station side switching unit 24. The terminal station wireless communication processing unit 23 has the same configuration as the terminal station wireless communication processing units 32-1, 32-2, . . . which are included in the ground station devices 3-1, 3a-1, 3-2, 3a-2, . . . in the first and second embodiments.

Either one function unit of the base station wireless communication processing unit 22 and the terminal station wireless communication processing unit 23 is connected to the mobile station antenna 21. The mobile station side switching unit 24 performs, upon receipt of a switching instruction signal transmitted by the switching instruction device 6, switching processing of switching a function unit to be connected to the mobile station antenna 21.

The ground station devices 3a-1, 3a-2, . . . are fixedly installed devices whose locations do not change, as with the ground station devices 3-1, 3-2, . . . of the first embodiment. Each of the ground station devices 3a-1, 3a-2, . . . has the same configuration; and each includes a ground station antenna 31-1, 31-2, . . . , a terminal station wireless communication processing unit 32-1, 32-2, . . . , a base station wireless communication processing unit 33-1, 33-2, . . . , and a ground station side switching unit 34-1, 34-2, . . . . The base station wireless communication processing units 33-1, 33-2, . . . have the same configuration as the base station wireless communication processing unit 22 that is included in the mobile station devices 2 and 2a in the first and second embodiments.

Either one function unit of the terminal station wireless communication processing unit 32-1, 32-2, . . . and the base station wireless communication processing unit 33-1, 33-2, . . . is connected to each of the ground station antennas 31-1, 31-2, . . . .

Each of the ground station side switching units 34-1, 34-2, . . . performs, upon receipt of a switching instruction signal transmitted by the switching instruction device 6, switching processing of switching a function unit to be connected to each corresponding ground station antenna 31-1, 31-2, . . . . In addition, when the base station wireless communication processing unit 22 is connected to the mobile station antenna 21 in the mobile station device 2a, each of the ground station side switching units 34-1, 34-2, . . . performs switching so as to cause the terminal station wireless communication processing unit 32-1, 32-2, . . . to be connected to each of the ground station antennas 31-1, 31-2, . . . . When the terminal station wireless communication processing unit 23 is connected to the mobile station antenna 21 in the mobile station device 2a, each of the ground station side switching units 34-1, 34-2, . . . performs switching so as to cause the base station wireless communication processing unit 33-1, 33-2, . . . to be connected to each of the ground station antennas 31-1, 31-2, . . . . In addition, each of the ground station side switching units 34-1, 34-2, . . . also performs switching processing of causing one of the function units that is connected to the ground station antenna 31-1, 3-2, . . . to be connected to the bridge device 4.

It should be noted that FIG. 3 illustrates, for convenience of description, a configuration in which connections to the mobile station antenna 21, the ground station antennas 31-1, 31-2, . . . and the bridge device 4 are physically switched. However, this switching is not limited to physical switching. For example, in the case of the mobile station device 2a, the base station wireless communication processing unit 22 and the terminal station wireless communication processing unit 23 are configured as an integrated module. Under such a situation, it is achieved by various means, for example: switching is performed by software setting such that when the module is being connected to the mobile station antenna 21 and either one of them is brought into an activation state, the other is brought into a stopped state; and switching is electrically performed by a configuration of an electronic circuit. Switching between the terminal station wireless communication processing units 32-1, 32-2 . . . and base station wireless communication processing units 33-1, 33-2, . . . of the ground station devices 3a-1, 3a-2, . . . is also achieved similarly by various means such as software setting. Specific examples of devices allowing switching between a base station function and a terminal station function as described above are a IEEE 802.11ad module and the like.

The switching instruction device 6 captures, for example, location information of the mobile station device 2a and the like as data indicating the characteristic of a radio propagation environment. The switching instruction device 6 determines, based on the captured data indicating the characteristics of a radio propagation environment, whether to perform a wireless connection equivalent to site diversity or to perform a wireless connection through handover. The switching instruction device 6 transmits a switching instruction signal to the mobile station device 2a and the ground station devices 3a-1, 3a-2, . . . via the bridge device 4, according to a determination result.

In addition, the switching instruction device 6 has an internal storage region store selection state data indicating which of the function units of the base station wireless communication processing unit 22 and the terminal station wireless communication processing unit 23 is being selected in the mobile station device 2a. In other words, the switching instruction device 6 has the internal storage region store the selection state data indicating which of the function units of the base station wireless communication processing unit 22 and the terminal station wireless communication processing unit 23 is being connected to the mobile station antenna 21.

(Wireless Connection Processing by the Wireless Communication System of the Second Embodiment)

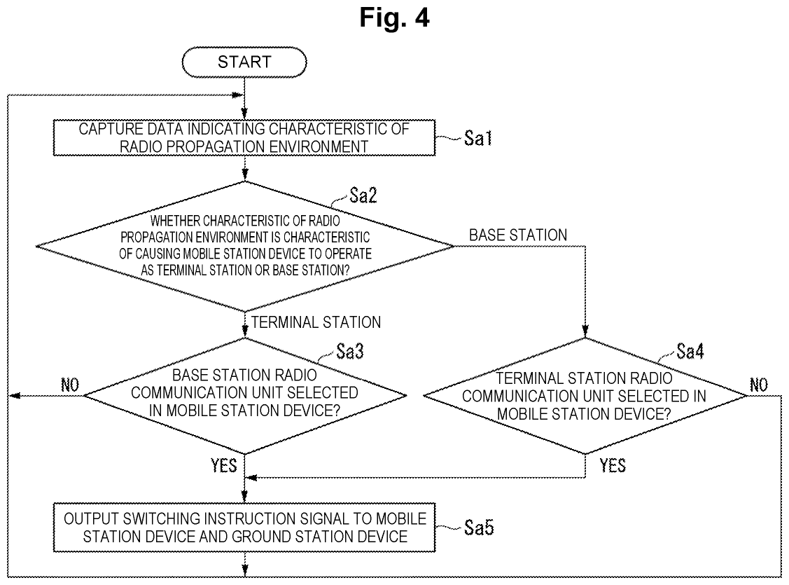

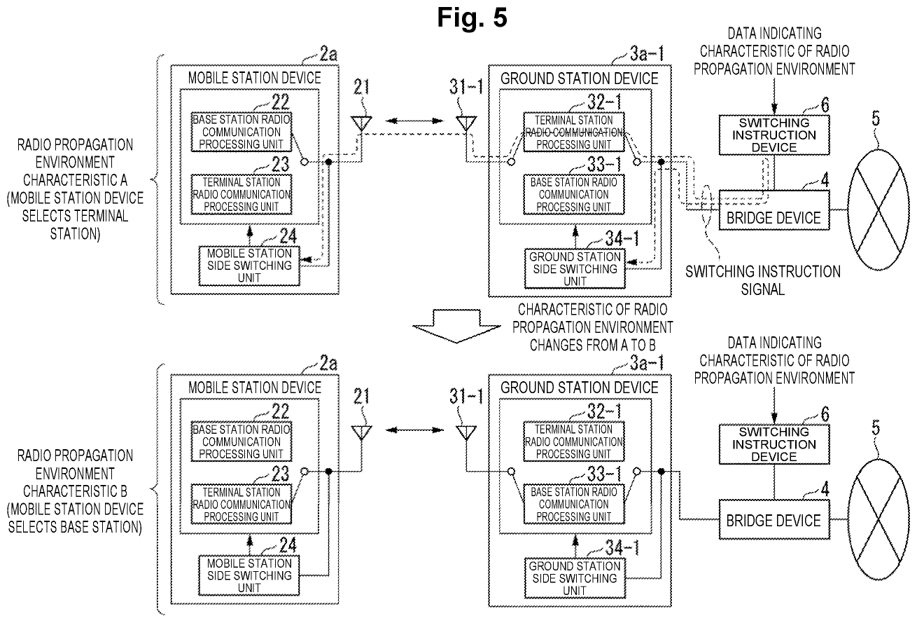

Next, wireless connection processing in the wireless communication system 1a of the first embodiment will be described with reference to FIG. 4. and FIG. 5. FIG. 4 is a flowchart illustrating a flow of processing by the switching instruction device 6; and FIG. 5 is a diagram indicating changes in the state of a wireless connection between the mobile station device 2a and the ground station device 3a-1 in the wireless communication system 1a.

Assume that in the initial state, the base station wireless communication processing unit 22 is being connected to the mobile station antenna 21 in the mobile station device 2a and the terminal station wireless communication processing unit 32-1 is being connected to the ground station antenna 31-1 and the bridge device 4 in the ground station device 3a-1.

It should be noted that although not illustrated in FIG. 5, the other ground station devices 3a-2, 3a-3, . . . have the same configuration as the ground station device 3a-1, and each of the terminal station wireless communication processing units 32-2, 32-3, . . . is connected with the ground station antenna 31-2, 32-3, . . . and the bridge device 4.

Assume that the mobile station device 2a is being connected by radio with the ground station device 3a-1 as shown in the upper illustration of FIG. 5. The switching instruction device 6 has the internal storage region store selection state data indicating that the base station wireless communication processing unit 22 is being selected in the mobile station device 2a.

Assume that the switching instruction device 6 captures “radio propagation environment characteristic A” as data indicating the characteristic of a radio propagation environment (step Sa1). The “radio propagation environment characteristic A” is assumed to be, for example, a radio propagation environment in which obstructions 50 and 51 exist between the mobile station device 2a and the ground station devices 3a-1, 3a-2, 3a-3, . . . and the mobile station device 2a is moving, as illustrated in FIG. 2 for the first embodiment.

The switching instruction device 6 determines whether the captured “radio propagation environment characteristic A” that is data indicating the characteristic of a radio propagation environment is a characteristic that causes the mobile station device 2a to operate as a terminal station wireless communication device or a characteristic that causes the mobile station device 2a to operate as a base station wireless communication device (step Sa2). The “radio propagation environment characteristic A” is a radio propagation environment illustrated in FIG. 2 for the first embodiment as described above. Therefore, the switching instruction device 6 determines that it is a characteristic that causes the mobile station device 2a to operate as a base station wireless communication device (step Sa2: base station).

The switching instruction device 6 refers to the selection state data stored in the internal storage region and determines whether the terminal station wireless communication processing unit 23 is being selected in the mobile station device 2a (step Sa4). When determining that the terminal station wireless communication processing unit 23 is being selected in the mobile station device 2a (step Sa4: Yes), the switching instruction device 6 advances processing to step Sa5 since switching is necessary. On the other hand, when determining that the terminal station wireless communication processing unit 23 is not being selected in the mobile station device 2a (step Sa4: No), switching is not necessary. Therefore, the switching instruction device 6 advances processing to step Sa1 without transmitting a switching instruction signal and captures, again, data indicating the characteristic of a radio propagation environment.

Here, as described above, data indicating that the base station wireless communication processing unit 22 is being selected in the mobile station device 2a is stored in the internal storage region of the switching instruction device 6. Therefore, the switching instruction device 6 determines that the terminal station wireless communication processing unit 23 is not being selected in the mobile station device 2a (step Sa4: No). Then, the switching instruction device 6 does not transmit a switching instruction signal; and the connection state of “radio propagation environment characteristic A” in the upper illustration of FIG. 5, that is, the initial state continues.

Next, assume that the characteristic of the radio propagation environment changes to “radio propagation environment characteristic B”. The “radio propagation environment characteristic B” is, for example, a radio propagation environment in which the mobile station device 2a is standing still. The switching instruction device 6 captures the “radio propagation environment characteristic B” as data indicating the characteristic of the radio propagation environment (step Sa1). The switching instruction device 6 determines that the captured “radio propagation environment characteristic B” that is data indicating the characteristic of the radio propagation environment is a characteristic that causes the mobile station device 2a to operate as a terminal station wireless communication device (step Sa2: terminal station).

The switching instruction device 6 refers to the selection state data stored in the internal storage region and determines whether the base station wireless communication processing unit 22 is being selected in the mobile station device 2a (step Sa3). When determining that the base station wireless communication processing unit 22 is being selected in the mobile station device 2a (step Sa3: Yes), the switching instruction device 6 advances processing to step Sa5 since switching is needed. On the other hand, when determining that the base station wireless communication processing unit 22 is not being selected in the mobile station device 2a (step Sa3: No), the switching instruction device 6 advances processing to step Sa1 without transmitting a switching instruction signal since switching is not necessary in this case, and captures, again, data indicating the characteristic of a radio propagation environment.

Here, as described above, data indicating that the base station wireless communication processing unit 22 is being selected in the mobile station device 2a is stored in the internal storage region of the switching instruction device 6. Therefore, the switching instruction device 6 determines that the base station wireless communication processing unit 22 is being selected in the mobile station device 2a (step Sa3: Yes); and transmits a switching instruction signal to the ground station devices 3a-1, 3a-2, . . . via the bridge device 4. In addition, the switching instruction device 6 transmits a switching instruction signal to the mobile station device 2a through a radio propagation path between the ground station device 3a-1 to which the mobile station device 2a is being connected by radio and the mobile station device 2a.

The switching instruction device 6 rewrites, after transmitting the switching instruction signal, the selection state data in the internal storage region into selection state data indicating that the terminal station wireless communication processing unit 23 is being selected in the mobile station device 2a (step Sa5).

Each of the ground station side switching units 34-1, 34-2, . . . of the ground station devices 3a-1, 3a-2, . . . performs, upon receipt of the switching instruction signal from the switching instruction device 6, switching processing so that the base station wireless communication processing unit 33-1, 33-2, . . . is connected to the ground station antenna 31-1, 31-2, . . . and the bridge device 4. In addition, the mobile station side switching unit 24 of the mobile station device 2a performs, upon receipt of a switching instruction signal from the switching instruction device 6, switching processing so that the terminal station wireless communication processing unit 23 is connected to the mobile station antenna 21.

This brings the state of a wireless connection of the wireless communication system 1a into a connection state of the “radio propagation environment characteristic B” in the lower illustration of FIG. 5.

If a further change from the “radio propagation environment characteristic B” to the “radio propagation environment characteristic A” is made, the switching instruction device 6 captures again, at step Sa1, the “radio propagation environment characteristic A” as data indicating the characteristic of a radio propagation environment. Then, the switching instruction device 6 determines, at step Sa2, that it is a characteristic of causing the mobile station device 2a to operate as a base station wireless communication device. At step Sa4, the switching instruction device 6 refers to selection state data stored in the internal storage region and this time, makes a determination of “Yes.” More specifically, the switching instruction device 6 determines that the terminal station wireless communication processing unit 23 is being selected in the mobile station device 2a. Then, the switching instruction device 6 transmits again, at step Sa5, a switching instruction signal to the ground station devices 3a-1, 3a-2, . . . and the mobile station device 2a.

This causes the ground station side switching units 34-1, 34-2, . . . of the ground station devices 3a-1, 3a-2, . . . and the mobile station side switching unit 24 of the mobile station device 2a to perform switching processing; and the wireless communication system 1a is again brought into the connection state of the “radio propagation environment characteristic A” in the upper illustration of FIG. 5.

According to the wireless communication system 1a of the second embodiment described above, it is possible to adaptively switch between the states according to the characteristic of a radio propagation environment: a state in which the mobile station device 2a is operated as a base station wireless communication device and the ground station devices 3a-1, 3a-2, . . . are operated as terminal station wireless communication devices; and a state in which the mobile station device 2a is operated as a terminal station wireless communication device and the ground station devices 3a-1, 3a-2, . . . are operated as base station wireless communication devices.

This makes it possible in the wireless communication system 1a that in the case of a radio propagation environment in which such obstructions 50 and 51 as illustrated in FIG. 2 of the first embodiment exist and the mobile station device 2a moves, a radio transmission can be maintained by a technique equivalent to site diversity as with the first embodiment.

However, in the wireless connection processing equivalent to site diversity according to the first embodiment, only one mobile station device 2a can be connected to the ground station devices 3a-1, 3a-2, . . . . Therefore, in a case where a plurality of mobile station devices 2a exist, it is better to allow, even when one mobile station device 2a is disconnected due to being in a non-line-of-sight environment, another mobile station device 2a to wirelessly connect to the ground station devices 3a-1, 3a-2, . . . , where the radio capacity of the overall system can be increased. Further, in a situation where the mobile station device 2a is standing still, lines of sight between the mobile station device 2a and the ground station devices 3a-1, 3a-2, . . . do not change and therefore, the handover technique suffices and it is desirable to set a state where the ground station devices 3a-1, 3a-2, . . . can perform a wireless connection with more other mobile station devices 2a.

Therefore, in the wireless communication system 1a, the mobile station device 2a is operated as a terminal station wireless communication device and the ground station devices 3a-1, 3a-2, . . . are operated as base station wireless communication devices in an environment where a wireless connection equivalent to site diversity is not necessary, where a radio transmission is maintained by the handover technique.

In the wireless communication system 1a of the second embodiment described above, the mobile station device 2a includes the base station wireless communication processing unit 22, the terminal station wireless communication processing unit 23, and the mobile station side switching unit 24. The mobile station side switching unit 24 switches between using the terminal station wireless communication processing unit 23 and the other, according to the characteristic of a radio propagation environment. In addition, each of the ground station devices 3a-1, 3a-2, . . . includes the terminal station wireless communication processing unit 32-1, 32-2, . . . , the base station wireless communication processing unit 33-1, 33-2, . . . , and the ground station side switching unit 34-1, 34-2, . . . . When the base station wireless communication processing unit 22 is in use in the mobile station device 2a, the ground station side switching units 34-1, 34-2, . . . cause the terminal station wireless communication processing units 32-1, 32-2, . . . to be used. Furthermore, when the terminal station wireless communication processing unit 23 is in use in the mobile station device 2a, the ground station side switching units 34-1, 34-2, . . . perform switching to using the base station wireless communication processing units 33-1, 33-2, . . . , according to the characteristic of a radio propagation environment. This makes it possible to adaptively switch between a wireless connection equivalent to site diversity and a wireless connection through handover according to the characteristic of a radio propagation environment between the mobile station device 2a and the ground station devices 3a-1, 3a-2, . . . .

### Third Embodiment

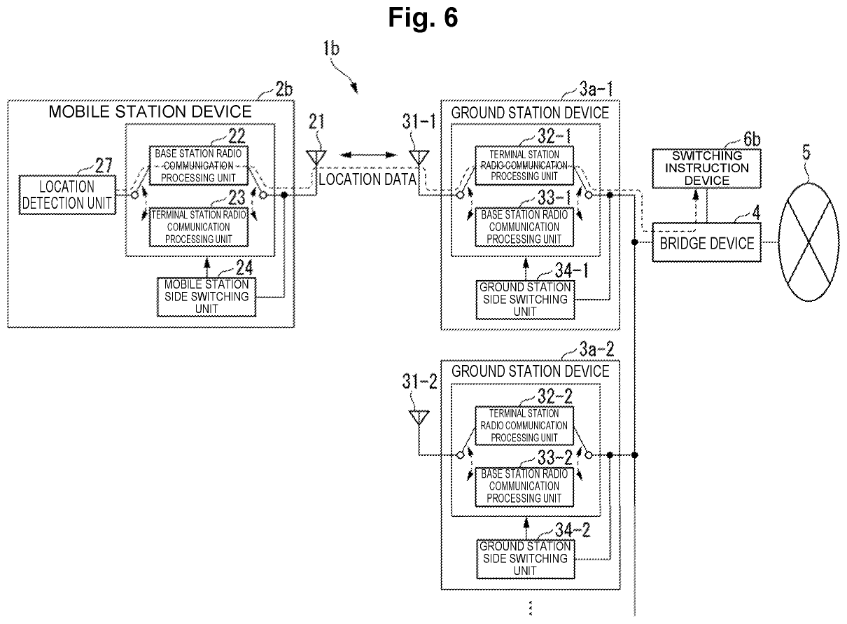

FIG. 6 is a block diagram illustrating a configuration of a wireless communication system 1b of a third embodiment. As for the wireless communication system 1b, the same components as those of the wireless communication systems 1 and 1a are denoted by the same reference signs and different components will be described below. The wireless communication system 1b includes a mobile station device 2b, a plurality of ground station devices 3a-1, 3a-2, . . . , a bridge device 4, a communication network 5, and a switching instruction device 6b. In the second embodiment, the ground station devices 3a-1, 3a-2, . . . , the communication network 5, and the switching instruction device 6b are connected to the bridge device 4.

In the wireless communication system 1b of the third embodiment, location data indicating the location of the mobile station device 2b is applied as data indicating the characteristic of a radio propagation environment which is provided to the switching instruction device 6 of the second embodiment.

The mobile station device 2b is a device that is allowed to move by being carried by a person or mounted on a vehicle, as with the mobile station device 2 of the first embodiment. It includes a mobile station antenna 21, a base station wireless communication processing unit 22, a terminal station wireless communication processing unit 23, a mobile station side switching unit 24, and a location detection unit 27. The location detection unit 27 is a global positioning system (GPS), for example, and detects location data indicating the location of the mobile station device 2b. The location detection unit 27 outputs the detected location data to either the base station wireless communication processing unit 22 or the terminal station wireless communication processing unit 23 that is being connected to the mobile station antenna 21, with the switching instruction device 6b set as a transmission destination. The location data is transmitted to the switching instruction device 6b through a radio propagation path between the mobile station device 2b and the ground station device 3a-1, 3a-2, . . . .

The switching instruction device 6b receives the location data transmitted by the location detection unit 27, via the bridge device 4. The switching instruction device 6b uses the received location data as data indicating the characteristic of a radio propagation environment; and based on the location data, determines whether to perform a wireless connection equivalent to site diversity or to perform a wireless connection through handover. The switching instruction device 6b transmits a switching instruction signal to the mobile station device 2b and the ground station devices 3a-1, 3a-2, . . . via the bridge device 4, according to a determination result.

In addition, the switching instruction device 6b has an internal storage region store selection state data indicating which of the function units of the base station wireless communication processing unit 22 and the terminal station wireless communication processing unit 23 is being selected in the mobile station device 2b. In other words, the switching instruction device 6b has the internal storage region store the selection state data indicating which of the function units of the base station wireless communication processing unit 22 and the terminal station wireless communication processing unit 23 is being connected to the mobile station antenna 21.

(Wireless Connection Processing by the Wireless Communication System of the Third Embodiment)

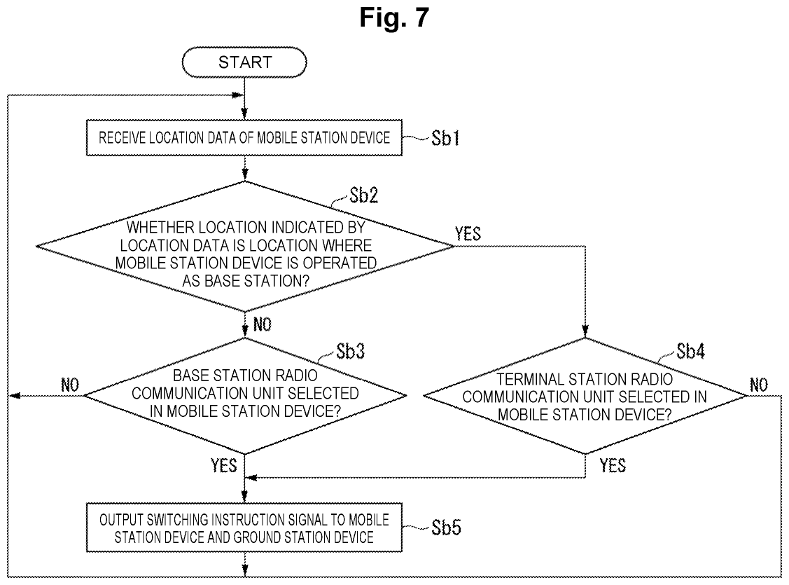

Next, wireless connection processing in the wireless communication system 1b of the third embodiment will be described with reference to a flowchart illustrated in FIG. 7.

Assume that in the initial state, as illustrated in FIG. 6, the base station wireless communication processing unit 22 is being connected to the location detection unit 27 and the mobile station antenna 21 in the mobile station device 2b and the terminal station wireless communication processing unit 32-1 is being connected to the ground station antenna 31-1 and the bridge device 4 in the ground station device 3a-1. It should be noted that the other ground station devices 3a-2, 3a-3, . . . have the same configuration as the ground station device 3a-1, and each of the terminal station wireless communication processing units 32-2, 32-3, . . . is connected with the ground station antenna 31-2, 32-3, . . . and with the bridge device 4.

In addition, assume that the mobile station device 2b is being connected by radio with the ground station device 3a-1. The switching instruction device 6b has an internal storage region store selection state data indicating that the base station wireless communication processing unit 22 is being selected in the mobile station device 2b.

The location detection unit 27 of the mobile station device 2b detects a location at fixed intervals and outputs location data indicating the detected location to the base station wireless communication processing unit 22, with the switching instruction device 6b set as a transmission destination. The base station wireless communication processing unit 22 captures the location data that is output by the location detection unit 27. Then, the base station wireless communication processing unit 22 transmits the captured location data to the ground station device 3a-1 that is being connected by radio to the mobile station device 2b, through the mobile station antenna 21.

The terminal station wireless communication processing unit 32-1 of the ground station device 3a-1 receives the location data that is transmitted by the location detection unit 27 through the ground station antenna 31-1. The terminal station wireless communication processing unit 32-1 transmits the received location data to the switching instruction device 6b via the bridge device 4.

The switching instruction device 6b receives and captures the location data that is transmitted by the terminal station wireless communication processing unit 32-1 (step Sb1). The switching instruction device 6b determines whether a location indicated by the captured location data is a location where the mobile station device 2b is operated as a base station wireless communication device (step Sb2).

For example, a vicinity of the location of the mobile station device 2b is partitioned into several areas in advance. Assume that an area A has a radio propagation environment where lines of sight are almost obtained between the mobile station device 2b and the ground station devices 3a-1, 3a-2, . . . and wireless connection processing equivalent to site diversity is not necessary, which is associated with data indicating the range of the area A in advance. In addition, assume that an area B has a radio propagation environment where there are several obstructions between the mobile station device 2b and the ground station devices 3a-1, 3a-2, . . . and wireless connection processing equivalent to site diversity is necessary, which is associated with data indicating the range of the area B in advance.

The switching instruction device 6b identifies an area in whose range the received location data is included, based on the characteristic of a radio propagation environment associated with each such area. The switching instruction device 6b determines whether it is a location where the mobile station device 2b is operated as a base station wireless communication device, according to the characteristic of a radio propagation environment which is associated with the identified area.

When determining that a location indicated by the location data is a location where the mobile station device 2b is operated as a base station wireless communication device (step Sb2: Yes), the switching instruction device 6b advances processing to step Sb4 so as to configure the wireless communication system 1b to perform a wireless connection equivalent to site diversity in the first embodiment. On the other hand, when determining that a location indicated by the location data is not a location where the mobile station device 2b is operated as a base station wireless communication device (step Sb2: No), the switching instruction device 6b advances processing to step Sb3 so as to configure the wireless communication system 1b to perform a wireless connection by the handover technique.

In steps Sb3, Sb4, and Sb5, the same processing as in the steps Sa3, Sa4, and Sa5 illustrated in FIG. 4 is performed by the switching instruction device 6b.

Thus, in the wireless communication system 1b, it is possible to identify the characteristic of a radio propagation environment between the mobile station device 2b and the ground station devices 3a-1, 3a-2, . . . , based on the location of the mobile station device 2b. In addition, it becomes possible to select whether to configure the wireless communication system 1b to perform wireless connection processing equivalent to site diversity, or to configure the wireless communication system 1b to perform wireless connection processing through handover, according to the identified characteristic.

(Another Configuration Example of the Third Embodiment)

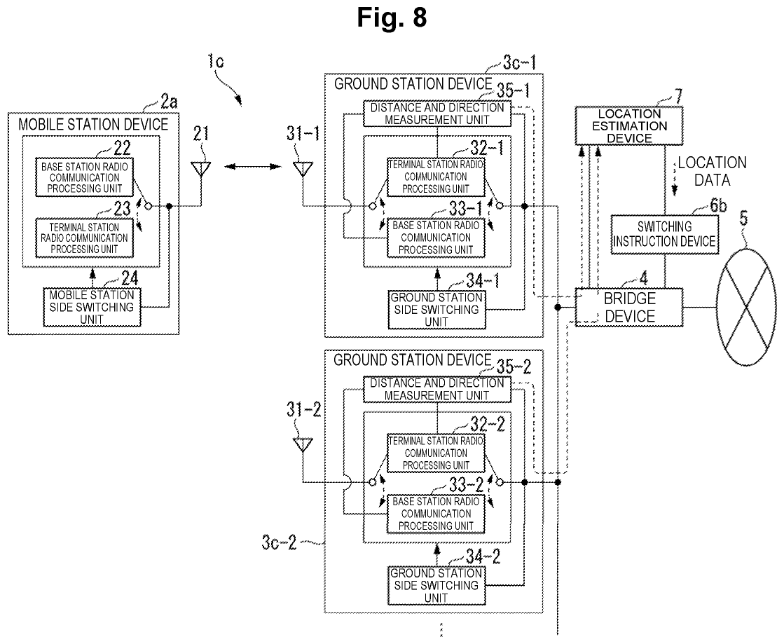

FIG. 8 is a block diagram illustrating a configuration of a wireless communication system 1c according to another configuration example of the third embodiment. As for the wireless communication system 1c, the same components as those of the wireless communication systems 1, 1a, and 1b are denoted by the same reference signs and different components will be described below.

The wireless communication system 1c includes a mobile station device 2a, a plurality of ground station devices 3c-1, 3c-2, . . . , a bridge device 4, a communication network 5, a switching instruction device 6b, and a location estimation device 7. In the wireless communication system 1c, the ground station devices 3c-1, 3c-2, . . . , the communication network 5, the switching instruction device 6b, and the location estimation device 7 are connected to the bridge device 4.

In a case where a high frequency band is used as a radio wave frequency, measurement of a distance by a wideband signal and estimation of a direction by using directional beams can be performed. By using them, the location of the mobile station device 2a can be estimated from the side of the ground station devices 3c-1, 3c-2, . . . .

The ground station devices 3c-1, 3c-2, . . . are fixedly installed devices whose locations do not change, as with the ground station devices 3-1, 3-2, . . . of the first embodiment. Each of the ground station devices 3c-1, 3c-2, . . . has the same configuration; and each includes a ground station antenna 31-1, 31-2, . . . , a terminal station wireless communication processing unit 32-1, 32-2, . . . , a base station wireless communication processing unit 33-1, 33-2, . . . , a ground station side switching unit 34-1, 34-2, . . . , and a distance and direction measurement unit 35-1, 35-2, . . . .

Each of the distance and direction measurement units 35-1, 35-2, . . . is connected to the terminal station wireless communication processing unit 32-1, 32-2, . . . and the base station wireless communication processing unit 33-1, 33-2, . . . ; and measures a distance to the mobile station device 2a using a wideband signal which is transmitted from the ground station antenna 31-1, 31-2, . . . . In addition, each of the distance and direction measurement units 35-1, 35-2, . . . detects a direction in which the mobile station device 2a is located, by using directional beams transmitted from the ground station antenna 31-1, 31-2, . . . . Each of the distance and direction measurement units 35-1, 35-2, . . . transmits distance data indicating the measured distance to the mobile station device 2a and direction data indicating the direction in which the mobile station device 2a is located, to the location estimation device 7 through the bridge device 4.

The location estimation device 7 receives the distance data and direction data which are transmitted by the distance and direction measurement units 35-1, 35-2, . . . through the bridge device 4, and estimates the location of the mobile station device 2a, based on the received distance data and direction data. The location estimation device 7 is connected to the switching instruction device 6b and outputs location data indicating the estimated location of the mobile station device 2a, to the switching instruction device 6b. The switching instruction device 6b captures the location data that is output by the location estimation device 7 and performs processing of a flowchart illustrated in FIG. 7.

Thus, as with the wireless communication system 1b, it becomes possible to select whether to configure the wireless communication system 1c to perform wireless connection processing equivalent to site diversity, or to configure the wireless communication system 1c to perform wireless connection processing through handover.

It should be noted that techniques for detecting the locations of the mobile station devices 2a and 2b are not limited to the techniques described for the wireless communication systems 1b and 1c and any technique may be applied.

### Fourth Embodiment

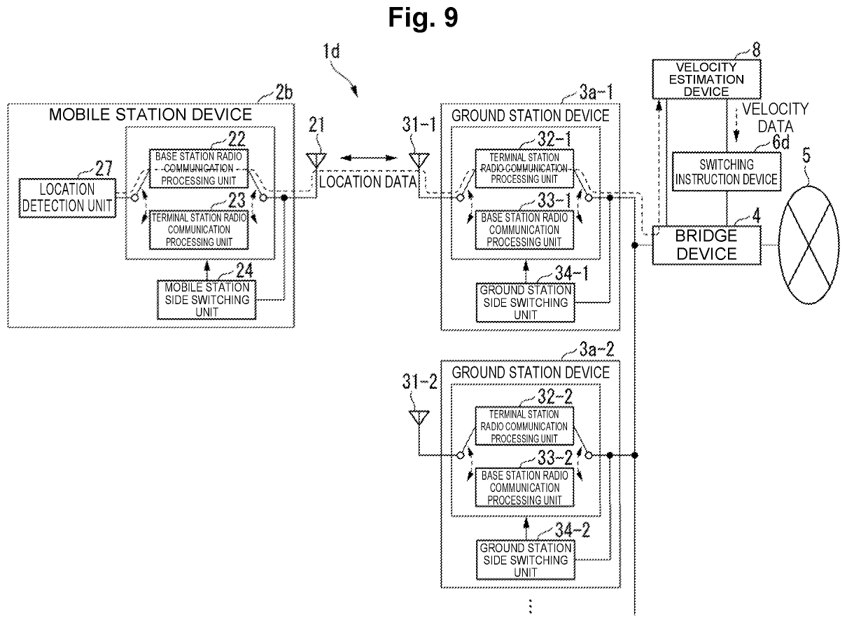

FIG. 9 is a block diagram illustrating a configuration of a wireless communication system 1d according to a fourth embodiment. As for the wireless communication system 1d, the same components as those of the wireless communication systems 1, 1a, 1b, and 1c are denoted by the same reference signs and different components will be described below.

The wireless communication system 1d includes a mobile station device 2b, a plurality of ground station devices 3a-1, 3a-2, . . . , a bridge device 4, a communication network 5, a switching instruction device 6d, and a velocity estimation device 8. In the fourth embodiment, the ground station devices 3a-1, 3a-2, . . . , the communication network 5, the switching instruction device 6d, and the velocity estimation device 8 are connected to the bridge device 4.

In the wireless communication system 1d of the fourth embodiment, velocity data indicating the moving velocity of the mobile station device 2b is applied as data indicating the characteristic of a radio propagation environment which is provided to the switching instruction device 6 of the second embodiment.

The velocity estimation device 8 sequentially captures the location data of the mobile station device 2b which is detected and transmitted by the location detection unit 27, via the bridge device 4. In the wireless communication system 1d of the fourth embodiment, the location detection unit 27 transmits the detected location data with the velocity estimation device 8 set as a transmission destination.

The velocity estimation device 8 calculates the velocity of the mobile station device 2b by calculating a difference vector between a plurality of pieces of the captured location data, for example. The velocity estimation device 8 is connected to the switching instruction device 6d and outputs velocity data indicating the calculated velocity, to the switching instruction device 6d.

The switching instruction device 6d captures the velocity data that is output by the velocity estimation device 8. The switching instruction device 6d uses the captured velocity data as data indicating the characteristic of a radio propagation environment; determines, based on the velocity data, whether to perform a wireless connection equivalent to site diversity or to perform a wireless connection through handover; and transmits, according to a determination result, a switching instruction signal to the mobile station device 2b and the ground station devices 3a-1, 3a-2, . . . via the bridge device 4.

In addition, the switching instruction device 6d has an internal storage region store selection state data indicating which of the function units of the base station wireless communication processing unit 22 and the terminal station wireless communication processing unit 23 is being selected in the mobile station device 2b, that is, which of the function units of the base station wireless communication processing unit 22 and the terminal station wireless communication processing unit 23 is being connected to the mobile station antenna 21.

(Wireless Connection Processing by the Wireless Communication System of the Fourth Embodiment)

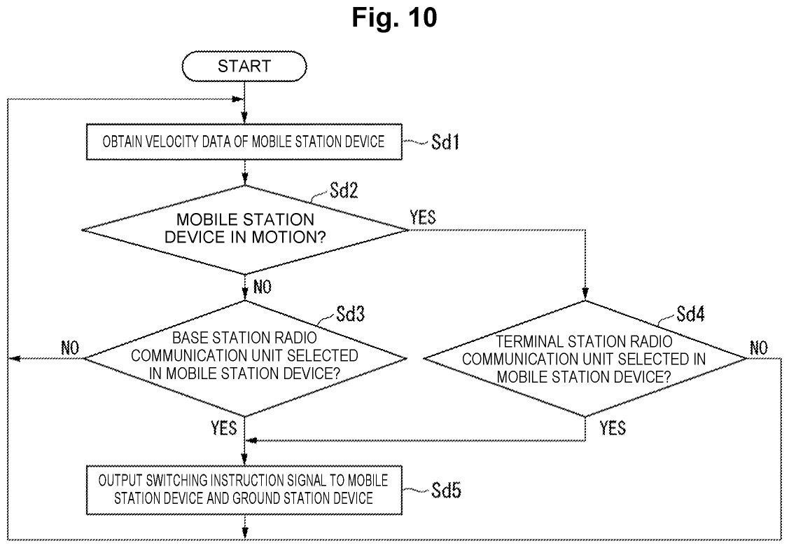

Next, wireless connection processing in the wireless communication system 1d of the fourth embodiment will be described with reference to a flowchart illustrated in FIG. 10.

Assume that in the initial state, as illustrated in FIG. 9, the base station wireless communication processing unit 22 is being connected to the location detection unit 27 and the mobile station antenna 21 in the mobile station device 2b and the terminal station wireless communication processing unit 32-1 is being connected to the ground station antenna 31-1 and the bridge device 4 in the ground station device 3a-1. It should be noted that the other ground station devices 3a-2, 3a-3, . . . have the same configuration as the ground station device 3a-1, and each of the terminal station wireless communication processing units 32-2, 32-3, . . . is connected with the ground station antenna 31-2, 32-3, . . . and with the bridge device 4.

In addition, assume that the mobile station device 2b is being connected by radio with the ground station device 3a-1. The switching instruction device 6d has an internal storage region store selection state data indicating that the base station wireless communication processing unit 22 is being selected in the mobile station device 2b.

The location detection unit 27 of the mobile station device 2b sequentially performs a detection of a location and repeats output of location data indicating the detected location to the base station wireless communication processing unit 22, with the velocity estimation device 8 set as a transmission destination. The base station wireless communication processing unit 22 transmits, when capturing the location data that is output by the location detection unit 27, the captured location data to the ground station device 3a-1 that is being connected by radio to the mobile station device 2b, through the mobile station antenna 21.

The terminal station wireless communication processing unit 32-1 of the ground station device 3a-1 receives the location data that is transmitted by the location detection unit 27 through the ground station antenna 31-1. The terminal station wireless communication processing unit 32-1 transmits the received location data to the velocity estimation device 8 via the bridge device 4.

The velocity estimation device 8 sequentially receives the location data that is transmitted by the terminal station wireless communication processing unit 32-1; and calculates the velocity of the mobile station device 2b by calculating a difference vector, based on a plurality of pieces of the received location data. The velocity estimation device 8 outputs velocity data indicating the calculated velocity, to the switching instruction device 6d. The switching instruction device 6d captures the velocity data that is output by the velocity estimation device 8 (step Sd1).

The switching instruction device 6b determines whether the mobile station device 2b is moving, based on the velocity indicated by the velocity data (step Sd2). The switching instruction device 6b determines that for example, if the velocity of the mobile station device 2b is a predetermined threshold or higher, the mobile station device 2b is in motion (step Sd2: Yes). When the mobile station device 2b is in motion, the line-of-sight environment of the mobile station device 2b changes with time, where a configuration for performing wireless connection processing equivalent to site diversity in the first embodiment becomes necessary. Therefore, the switching instruction device 6b advances processing to step Sd4.

On the other hand, if the velocity of the mobile station device 2b is lower than a predetermined threshold, the switching instruction device 6b determines that the mobile station device 2b is not in motion (step Sb2: No). When the mobile station device 2b is not in motion, the line-of-sight environment of the mobile station device 2b does not change. Thus, a configuration for performing wireless connection processing through handover suffices and therefore, the switching instruction device 6b advances processing to step Sd3.

In steps Sd3, Sd4, and Sd5, the same processing as in the steps Sa3, Sa4, and Sa5 illustrated in FIG. 4 is performed by the switching instruction device 6d.

Thus, in the wireless communication system 1d, it is possible to identify the characteristic of a radio propagation environment between the mobile station device 2b and the ground station devices 3a-1, 3a-2, . . . , based on the velocity of the mobile station device 2b. In addition, it becomes possible to adaptively switch between configuring the wireless communication system 1d to perform wireless connection processing equivalent to site diversity and configuring the wireless communication system 1d to perform wireless connection processing through handover, according to the identified characteristic.

It should be noted that in the wireless communication system 1d, instead of providing the velocity estimation device 8, the mobile station device 2b may include an acceleration sensor, gyroscope, and the like in place of the location detection unit 27. In this case, the velocity of the mobile station device 2b is calculated by using acceleration and direction detected by the acceleration sensor and gyroscope, and velocity data indicating the calculated velocity is transmitted to the switching instruction device 6d.

In addition, a technique for obtaining the velocity of the mobile station device 2a is not limited to the technique described for the wireless communication system 1d and any technique may be applied. For example, assume that in the wireless communication system 1c illustrated in FIG. 8, a configuration is such that the switching instruction device 6d is provided in place of the switching instruction device 6b and further, the velocity estimation device 8 is connected between the location estimation device 7 and the switching instruction device 6d. In the wireless communication system 1c thus configured, the velocity estimation device 8 may calculate the velocity of the mobile station device 2a based on location data indicating the location of the mobile station device 2a that is estimated by the location estimation device 7; and, based on the calculated velocity, the switching instruction device 6d may perform processing of the flowchart illustrated in FIG. 10.

### Fifth Embodiment

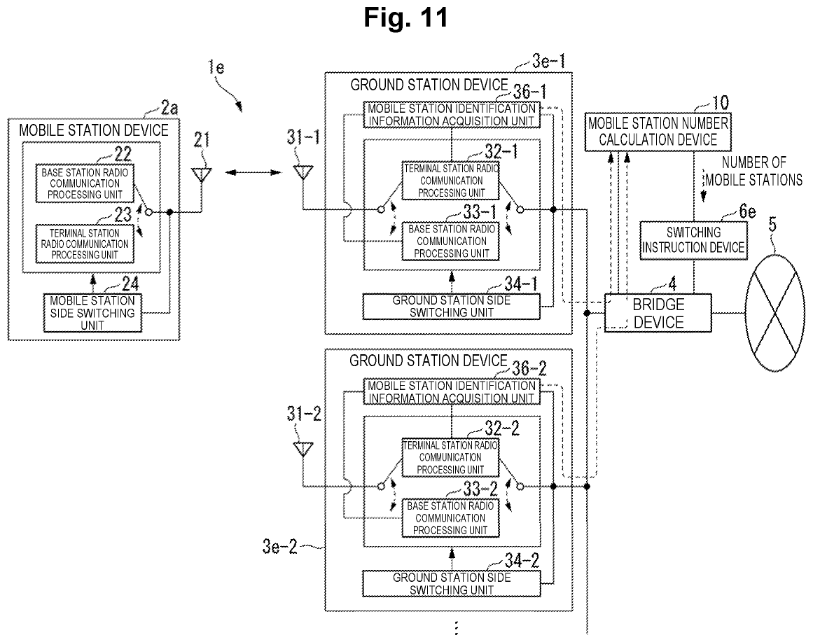

FIG. 11 is a block diagram illustrating a configuration of a wireless communication system 1e according to a fifth embodiment. As for the wireless communication system 1e, the same components as those of the wireless communication systems 1, 1a, 1b, 1c, and 1d are denoted by the same reference signs and different components will be described below.

The wireless communication system 1e includes a mobile station device 2a, a plurality of ground station devices 3e-1, 3e-2, . . . , a bridge device 4, a communication network 5, a switching instruction device 6e, and a mobile station number calculation device 10. In the wireless communication system 1e, the ground station devices 3e-1, 3e-2, . . . , the communication network 5, the switching instruction device 6e, and the mobile station number calculation device 10 are connected to the bridge device 4.

In the wireless communication system 1e of the fifth embodiment, the number of mobile station devices 2a to be connected to the ground station devices 3e-1, 3e-2, . . . , that is the number of mobile stations is applied, as data indicating the characteristic of a radio propagation environment which is provided to the switching instruction device 6 of the second embodiment.

The ground station devices 3e-1, 3e-2, . . . are fixedly installed devices whose locations do not change, as with the ground station devices 3-1, 3-2, . . . of the first embodiment. Each of the ground station devices 3e-1, 3e-2, . . . has the same configuration; and each includes a ground station antenna 31-1, 31-2, . . . , a terminal station wireless communication processing unit 32-1, 32-2, . . . , a base station wireless communication processing unit 33-1, 33-2, . . . , a ground station side switching unit 34-1, 34-2, . . . , and a mobile station identification information acquisition unit 36-1, 36-2, . . . .

Each of the mobile station identification information acquisition units 36-1, 36-2, . . . is connected to the terminal station wireless communication processing unit 32-1, 32-2, . . . and base station wireless communication processing unit 33-1, 33-2, . . . ; and obtains mobile station identification information of a mobile station device 2a that is being connected by radio to each corresponding ground station device 3e-1, 3e-2, . . . , from either of the function units of the terminal station wireless communication processing unit 32-1, 32-2, . . . and the base station wireless communication processing unit 33-1, 33-2, . . . that is being connected to the ground station antenna 31-1-, 31-2, . . . .

The mobile station identification information is information that is provided to a mobile station device 2a in advance and allows each mobile station device 2a to be identified; and may be, for example, a media access control (MAC) address. In addition, each of the terminal station wireless communication processing units 32-1, 32-2, . . . and base station wireless communication processing units 33-1, 33-2, . . . of the ground station devices 3e-1, 3e-2, . . . has, stored in an internal storage region, mobile station identification information of a mobile station device 2a that is being connected by radio.

Each of the mobile station identification information acquisition units 36-1, 36-2, . . . transmits the obtained mobile station identification information to the mobile station number calculation device 10 via the bridge device 4.

The mobile station number calculation device 10 receives the mobile station identification information that is transmitted by each of the mobile station identification information acquisition units 36-1, 36-2 . . . . The mobile station number calculation device 10 calculates the number of pieces of mobile station identification information, that is, the number of mobile stations, after removing redundant mobile station identification information from the received mobile station identification information. The mobile station number calculation device 10 is connected to the switching instruction device 6e and outputs the calculated number of mobile stations to the switching instruction device 6e.

The switching instruction device 6e captures the number of mobile stations that is output by the mobile station number calculation device 10; uses the captured number of mobile stations as data indicating the characteristic of a radio propagation environment; and based on the number of mobile stations, determines whether to perform a wireless connection equivalent to site diversity or to perform a wireless connection through handover. Then, the switching instruction device 6e transmits a switching instruction signal to the mobile station device 2a and the ground station devices 3e-1, 3e-2, . . . via the bridge device 4, according to a determination result.

In addition, the switching instruction device 6e has an internal storage region store selection state data indicating which of the function units of the base station wireless communication processing unit 22 and the terminal station wireless communication processing unit 23 is being selected in the mobile station device 2a, that is, which of the function units of the base station wireless communication processing unit 22 and the terminal station wireless communication processing unit 23 is being connected to the mobile station antenna 21.

(Wireless Connection Processing by the Wireless Communication System of the Fifth Embodiment)

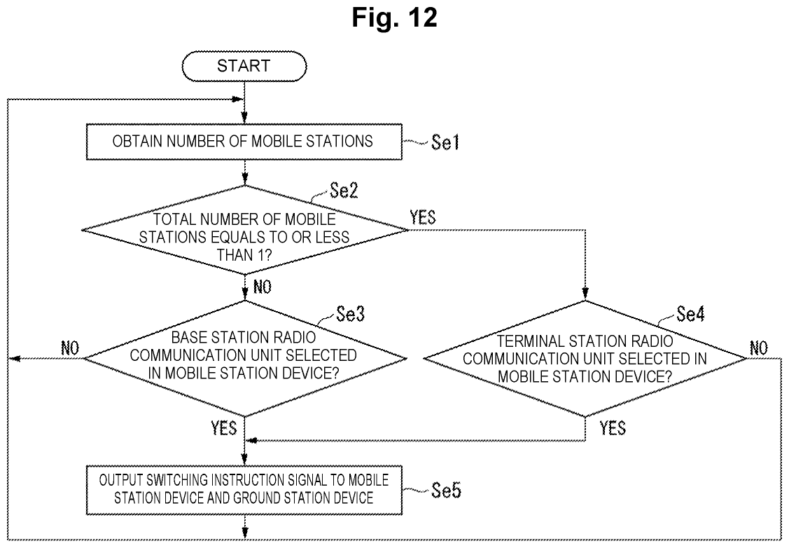

Next, wireless connection processing in the wireless communication system 1e of the fifth embodiment will be described with reference to a flowchart illustrated in FIG. 12.

Assume that in the initial state, as illustrated in FIG. 11, the base station wireless communication processing unit 22 is being connected to the mobile station antenna 21 in the mobile station device 2a and the terminal station wireless communication processing unit 32-1 is being connected to the ground station antenna 31-1 and the bridge device 4 in the ground station device 3e-1. It should be noted that the other ground station devices 3e-2, 3e-3, . . . have the same configuration as the ground station device 3e-1, and each of the terminal station wireless communication processing units 32-2, 32-3, . . . is connected with the ground station antenna 31-2, 31-3, . . . and with the bridge device 4.

In addition, assume that the mobile station device 2a is being connected by radio with the ground station device 3e-1.

The switching instruction device 6e has an internal storage region store selection state data indicating that the base station wireless communication processing unit 22 is being selected in the mobile station device 2a.

In other words, in the initial state, the mobile station device 2a and the ground station devices 3e-1, 3e-2, . . . are being connected by radio by a technique equivalent to site diversity. Thus, there is a state in which a plurality of ground station devices 3e-1, 3e-2, . . . can be connected by radio to one mobile station device 2a. In this case, when a plurality of mobile station devices 2a exist, each of the ground station devices 3e-1, 3e-2, . . . may wirelessly connect to the same mobile station device 2a or may wirelessly connect to a different mobile station device 2a.

Each of the mobile station identification information acquisition units 36-1, 36-2, . . . of the ground station devices 3e-1, 3e-2, . . . obtains mobile station identification information of a mobile station device 2a that is being connected by radio, from an internal storage region of the terminal station wireless communication processing unit 32-1, 32-2, . . . . Each of the mobile station identification information acquisition units 36-1, 36-2, . . . transmits the obtained mobile station identification information to the mobile station number calculation device 10 via the bridge device 4.

The mobile station number calculation device 10 receives the mobile station identification information that is transmitted by each of the mobile station identification information acquisition units 36-1, 36-2, . . . . The mobile station number calculation device 10 calculates the number of pieces of mobile station identification information, that is, the number of mobile stations, after removing redundant mobile station identification information from the received mobile station identification information. The mobile station number calculation device 10 outputs the calculated number of mobile stations to the switching instruction device 6e.

The switching instruction device 6e captures the number of mobile stations that is output by the mobile station number calculation device 10 (step Se1). The switching instruction device 6e determines whether the captured number of mobile stations is equal to or less than “1” (step Se2).

When the total value of the number of mobile stations is equal to or smaller than “1,” the number of the mobile station devices 2a included in the wireless communication system 1e is zero or one; and in this case, if configuration is made so as to perform a wireless connection equivalent to site diversity in the first embodiment, no disadvantage is given.

On the other hand, when the total value of the number of mobile stations is not equal to or smaller than “1,” a plurality of mobile station devices 2a exist in the wireless communication system 1e. In this case, if configuration is made so as to perform a wireless connection equivalent to site diversity in the first embodiment, only one of the mobile station devices 2a can wirelessly connect to the ground station devices 3e-1, 3e-2, . . . , this causing a disadvantage of reducing the radio capacity of the overall system.

Therefore, if determining that a total value of the number of mobile stations is equal to or smaller than “1” (step Se2: Yes), the switching instruction device 6e advances processing to step Se4 so as to configure the wireless communication system 1e to perform a wireless connection equivalent to site diversity in the first embodiment.

On the other hand, if determining that a total value of the number of mobile stations is not equal to or smaller than “1” (step Se2: No) the switching instruction device 6e advances processing to step Se3 so as to configure the wireless communication system 1e to perform a wireless connection by the handover technique.

In steps Se3, Se4, and Se5, the same processing as in the steps Sa3, Sa4, and Sa5 illustrated in FIG. 4 is performed by the switching instruction device 6d.

Thus, in the wireless communication system 1e, it is possible to identify the characteristic of a radio propagation environment between the mobile station device 2a and the ground station devices 3e-1, 3e-2, . . . , based on the number of mobile station devices 2a. In addition, it becomes possible to adaptively switch between configuring the wireless communication system 1e to perform wireless connection processing equivalent to site diversity and configuring the wireless communication system 1e to perform wireless connection processing through handover, according to the identified characteristic.

It should be noted that a technique for calculating the number of mobile stations is not limited to the technique described for the wireless communication system 1e and any technique may be applied. For example, in a configuration of the wireless communication system 1b or 1c of the third embodiment, a technique of measuring the number of mobile station devices 2a or 2b that exist in a target area from the locations of the mobile station devices 2a or 2b may be applied. In addition, in a case where mobile station devices 2a are carried by persons, the number of mobile station devices 2a may be measured by measuring the number of persons who have entered the area by, for example, gate checking.

### Sixth Embodiment

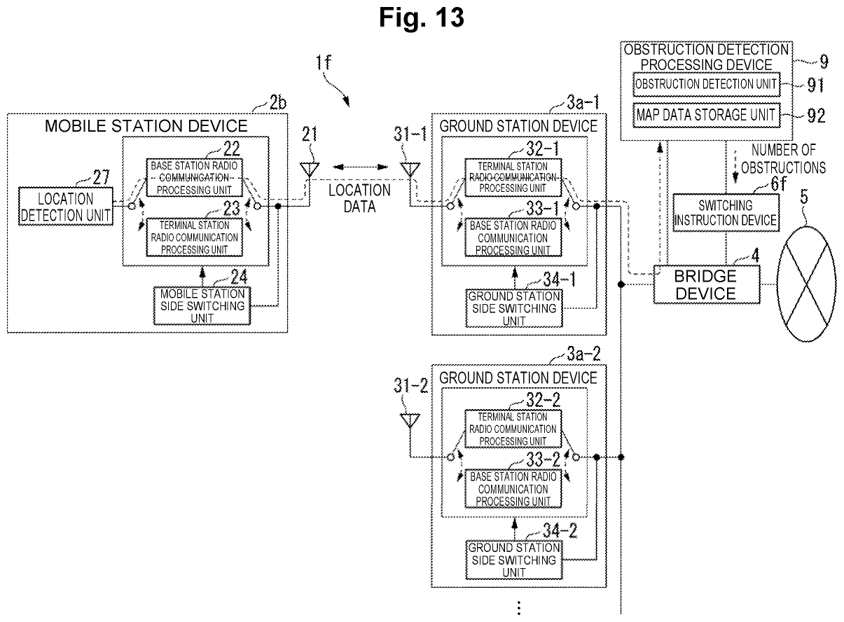

FIG. 13 is a block diagram illustrating a configuration of a wireless communication system 1f according to a sixth embodiment. As for the wireless communication system 1f, the same components as those of the wireless communication systems 1, 1a, 1b, 1c, 1d, and 1e are denoted by the same reference signs and different components will be described below.

The wireless communication system 1f includes a mobile station device 2b, a plurality of ground station devices 3a-1, 3a-2, . . . , a bridge device 4, a communication network 5, a switching instruction device 6f, and an obstruction detection processing device 9. In the sixth embodiment, the ground station devices 3a-1, 3a-2, . . . , the communication network 5, the switching instruction device 6f, and the obstruction detection processing device 9 are connected to the bridge device 4.

In the wireless communication system 1f of the sixth embodiment, data indicating a line-of-sight state between the mobile station device 2b and the ground station devices 3a-1, 3a-2, . . . is applied as data indicating the characteristic of a radio propagation environment which is provided to the switching instruction device 6 of the second embodiment.

The obstruction detection processing device 9 includes an obstruction detection unit 91 and a map data storage unit 92. The map data storage unit 92 stores three-dimensional map data. The obstruction detection unit 91 captures location data of the mobile station device 2b that is detected and transmitted by the location detection unit 27, via the bridge device 4. In the wireless communication system 1f of the sixth embodiment, the location detection unit 27 transmits the detected location data with the obstruction detection processing device 9 set as a transmission destination.

The obstruction detection unit 91 has an internal storage region store, in advance, location data indicating the location of the ground station devices 3a-1, 3a-2, . . . . The obstruction detection unit 91 detects the number of obstructions that exist between the mobile station device 2b and each of the ground station devices 3a-1, 3a-2, . . . as data indicating a line-of-sight state between the mobile station device 2b and each of the ground station devices 3a-1, 3a-2, . . . , based on the captured location data of the mobile station device 2b, the location data of the ground station devices 3a-1, 3a-2, . . . stored by the internal storage region, and the three-dimensional map data stored by the map data storage unit 92. The obstruction detection unit 91 is connected to the switching instruction device 6f and outputs the detected number of obstructions to the switching instruction device 6f.

The switching instruction device 6f captures the number of obstructions that is output by the obstruction detection unit 91. The switching instruction device 6f uses the captured number of obstructions as data indicating the characteristic of a radio propagation environment; and based on the number of obstructions, determines whether to perform a wireless connection equivalent to site diversity or to perform a wireless connection through handover. In addition, the switching instruction device 6f transmits a switching instruction signal to the mobile station device 2b and the ground station devices 3a-1, 3a-2, . . . via the bridge device 4, according to a determination result.

Further, the switching instruction device 6f has an internal storage region store selection state data indicating which of the function units of the base station wireless communication processing unit 22 and the terminal station wireless communication processing unit 23 is being selected in the mobile station device 2b, that is, which of the function units of the base station wireless communication processing unit 22 and the terminal station wireless communication processing unit 23 is being connected to the mobile station antenna 21.

(Wireless Connection Processing by the Wireless Communication System of the Sixth Embodiment)

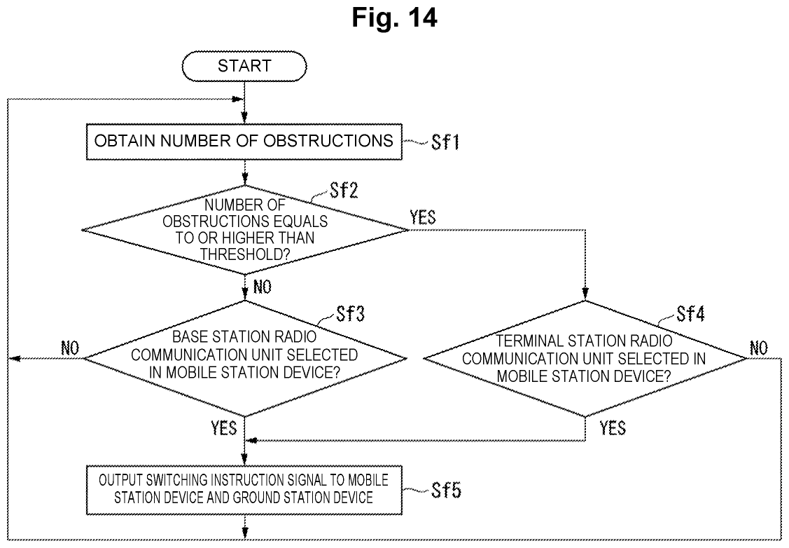

Next, wireless connection processing in the wireless communication system 1f of the sixth embodiment will be described with reference to a flowchart illustrated in FIG. 14.

Assume that in the initial state, as illustrated in FIG. 13, the base station wireless communication processing unit 22 is connected to the location detection unit 27 and the mobile station antenna 21 in the mobile station device 2b and the terminal station wireless communication processing unit 32-1 is connected to the ground station antenna 31-1 and the bridge device 4 in the ground station device 3a-1. It should be noted that the other ground station devices 3a-2, 3a-3, . . . have the same configuration as the ground station device 3a-1, and each of the terminal station wireless communication processing units 32-2, 32-3, . . . is connected with the ground station antenna 31-2, 31-3, . . . and with the bridge device 4.

In addition, assume that the mobile station device 2b is being connected by radio with the ground station device 3a-1.

The switching instruction device 6f has an internal storage region store selection state data indicating that the base station wireless communication processing unit 22 is being selected in the mobile station device 2b.

The location detection unit 27 of the mobile station device 2b detects a location and outputs location data indicating the detected location to the base station wireless communication processing unit 22, with the obstruction detection processing device 9 set as a transmission destination. The base station wireless communication processing unit 22 transmits, when capturing the location data that is output by the location detection unit 27, the captured location data to the ground station device 3a-1 that is being connected by radio to the mobile station device 2b, through the mobile station antenna 21.

The terminal station wireless communication processing unit 32-1 of the ground station device 3a-1 receives the location data that is transmitted by the location detection unit 27 through the ground station antenna 31-1. The terminal station wireless communication processing unit 32-1 transmits the received location data to the obstruction detection processing device 9 via the bridge device 4.

The obstruction detection unit 91 captures location data of the mobile station device 2b which is detected and transmitted by the location detection unit 27, via the bridge device 4. The obstruction detection unit 91 detects the number of obstructions obstructing the radio propagation that exist between the mobile station device 2b and each of the ground station devices 3a-1, 3a-2, . . . , based on the captured location data of the mobile station device 2b, the location data of the ground station devices 3a-1, 3a-2, . . . stored by the internal storage region, and the three-dimensional map data stored by the map data storage unit 92. The obstruction detection unit 91 outputs the detected number of obstructions to the switching instruction device 6f.

The switching instruction device 6f captures the number of obstructions that is output by the obstruction detection unit 91 (step Sf1). The switching instruction device 6f determines whether the captured number of obstructions is equal to or more than a predetermined threshold (step Sf2).

Assume that the switching instruction device 6f determines that the number of obstructions is equal to or more than the predetermined threshold (step Sf2: Yes). In this case, the number of obstructions is the threshold or more and therefore, it can be considered that an environment in which the mobile station device 2b and the ground station devices 3a-1, 3a-2, . . . are located is a non-line-of-sight environment in which there is no line of sight. In the case of a non-line-of-sight environment, a configuration for performing wireless connection processing equivalent to site diversity in the first embodiment becomes necessary. Therefore, the switching instruction device 6f advances processing to step Sf4.

On the other hand, assume that the switching instruction device 6f determines that the number of obstructions is not equal to or more than the predetermined threshold (step Sf2: No). In this case, the number of obstructions is less than the threshold and therefore, it can be considered that an environment in which the mobile station device 2b and the ground station device 3a-1, 3a-2, . . . are located is a line-of-sight environment in which there is a line of sight. In the case of a line-of-sight environment, a configuration for performing wireless connection processing through handover suffices and therefore, the switching instruction device 6f advances processing to step Sf3.

In steps Sf3, Sf4, and Sf5, the same processing as in the steps Sa3, Sa4, and Sa5 illustrated in FIG. 4 is performed by the switching instruction device 6f.

Thus, in the wireless communication system 1f, it is possible to identify the characteristic of a radio propagation environment between the mobile station device 2b and the ground station devices 3a-1, 3a-2, . . . , based on the number of obstructions that exist between the mobile station device 2b and each of the ground station devices 3a-1, 3a-2, . . . . In addition, it becomes possible to adaptively switch between configuring the wireless communication system 1f to perform wireless connection processing equivalent to site diversity and configuring the wireless communication system 1f to perform wireless connection processing through handover, according to the identified characteristic.

It should be noted that a technique for detecting the location of the mobile station device 2a is not limited to the technique described for the wireless communication system 1f and any technique may be applied. For example, assume that in the wireless communication system 1c illustrated in FIG. 8, a configuration is such that the switching instruction device 6f is provided in place of the switching instruction device 6b and further, the obstruction detection processing device 9 is connected between the location estimation device 7 and the switching instruction device 6f. In the wireless communication system 1c thus configured, the obstruction detection processing device 9 may detect the number of obstructions based on the location data indicating the location of the mobile station device 2a that is estimated by the location estimation device 7; and based on the detected number of obstructions, the switching instruction device 6f may perform processing of the flowchart illustrated in FIG. 14.

In addition, a technique for detecting the number of obstructions by the obstruction detection unit 91 is not limited to the technique described for the wireless communication system 1f and any technique may be applied. For example, a technique of detecting, when the mobile station device 2b includes a radar or the like, the number of obstructions that exist between the mobile station device 2b and the ground station devices 3a-1, 3a-2, . . . by using the radar may be applied. Alternatively, a technique of estimating the number of obstructions by using radio waves between the mobile station device 2b and the ground station devices 3a-1, 3a-2, . . . may be applied

Furthermore, in the fifth embodiment described above, the number of obstructions is applied as data indicating a line-of-sight state between the mobile station device 2b and the ground station devices 3a-1, 3a-2, . . . ; however, data indicating the line-of-sight state may be, in place of the number of obstructions, the size of each obstruction, a percentage obstructed by an obstruction in a space between the mobile station device 2b and each of the ground station devices 3a-1, 3a-2, . . . , or the like. In this case, the switching instruction device 6f uses the size of each obstruction or the obstructed percentage as data indicating the characteristic of a radio propagation environment; and based on the data, determines whether to perform a wireless connection equivalent to site diversity or to perform a wireless connection through handover.

### Seventh Embodiment

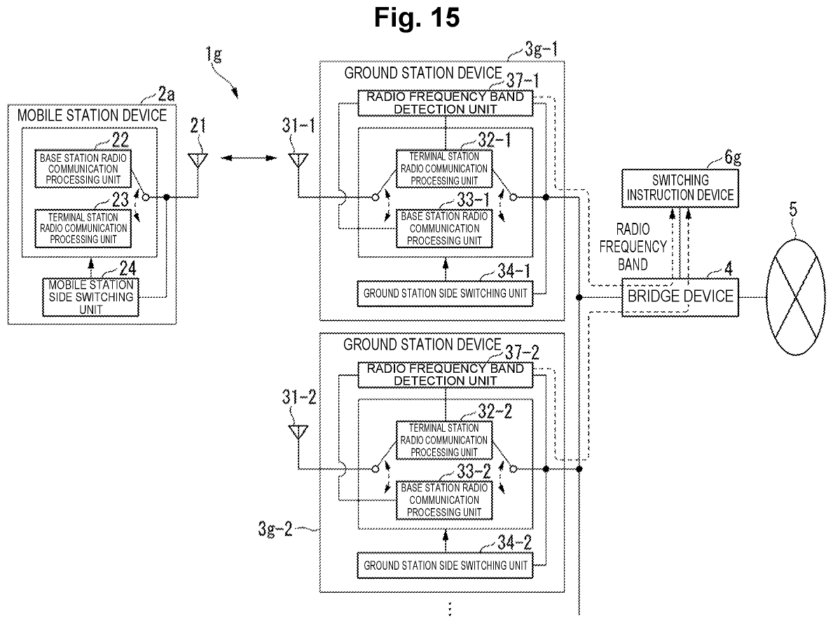

FIG. 15 is a block diagram illustrating a configuration of a wireless communication system 1g according to a seventh embodiment. As for the wireless communication system 1g, the same components as those of the wireless communication systems 1, 1a, 1b, 1c, 1d, 1e, and 1f are denoted by the same reference signs and different components will be described below.

The wireless communication system 1g includes a mobile station device 2a, a plurality of ground station devices 3g-1, 3g-2, . . . , a bridge device 4, a communication network 5, and a switching instruction device 6g. In the wireless communication system 1g, the ground station devices 3g-1, 3g-2, . . . the communication network 5, and the switching instruction device 6g are connected to the bridge device 4.

In the wireless communication system 1g of the seventh embodiment, a radio frequency band used by the mobile station device 2a and the ground station devices 3e-1, 3e-2, . . . is applied as data indicating the characteristic of a radio propagation environment which is provided to the switching instruction device 6 of the second embodiment.

The ground station devices 3g-1, 3g-2, . . . are fixedly installed devices whose locations do not change, as with the ground station devices 3-1, 3-2, . . . of the first embodiment. Each of the ground station devices 3g-1, 3g-2, . . . has the same configuration; and each includes a ground station antenna 31-1, 31-2, . . . , a terminal station wireless communication processing unit 32-1, 32-2, . . . , a base station wireless communication processing unit 33-1, 33-2, . . . , a ground station side switching unit 34-1, 34-2, . . . , and a radio frequency band detection unit 37-1, 37-2, . . . .

Each of the radio frequency band detection units 37-1, 37-2, . . . is connected to the terminal station wireless communication processing unit 32-1, 32-1, . . . and base station wireless communication processing unit 33-1, 33-2, . . . ; and detects a radio frequency band that is being used with the mobile station device 2a, from either of the function units of the terminal station wireless communication processing unit 32-1, 32-2, . . . or the base station wireless communication processing unit 33-1, 33-2, . . . that is being connected to the ground station antenna 31-1, 31-2, . . . .

It should be noted that it is assumed that each of the ground station devices 3g-1, 3g-2, . . . is being connected by radio with the mobile station device 2a by using the same radio frequency band. Therefore, even when each of the ground station devices 3g-1, 3g-2, . . . is being connected by radio with a different mobile station device 2a, a radio frequency band that is detected by each of the radio frequency band detection units 37-1, 37-2, . . . indicates the same radio frequency band.

Each of the radio frequency band detection units 37-1, 37-2, . . . transmits radio frequency band data indicating the detected radio frequency band to the switching instruction device 6g via the bridge device 4.

The switching instruction device 6g receives the radio frequency band data that is transmitted by each of the radio frequency band detection units 37-1, 37-2, . . . . The switching instruction device 6e uses the received radio frequency band data as data indicating the characteristic of a radio propagation environment; and based on the radio frequency band data, determines whether to perform a wireless connection equivalent to site diversity or to perform a wireless connection through handover. The switching instruction device 6g transmits a switching instruction signal to the mobile station device 2a and the ground station devices 3g-1, 3g-2, . . . via the bridge device 4, according to a determination result.

In addition, the switching instruction device 6g has an internal storage region store selection state data indicating which of the function units of the base station wireless communication processing unit 22 and the terminal station wireless communication processing unit 23 is being selected in the mobile station device 2a. That is, the switching instruction device 6g has it store selection state data indicating which of the function units of the base station wireless communication processing unit 22 and the terminal station wireless communication processing unit 23 is being connected to the mobile station antenna 21.

(Wireless Connection Processing by the Wireless Communication System of the Seventh Embodiment)

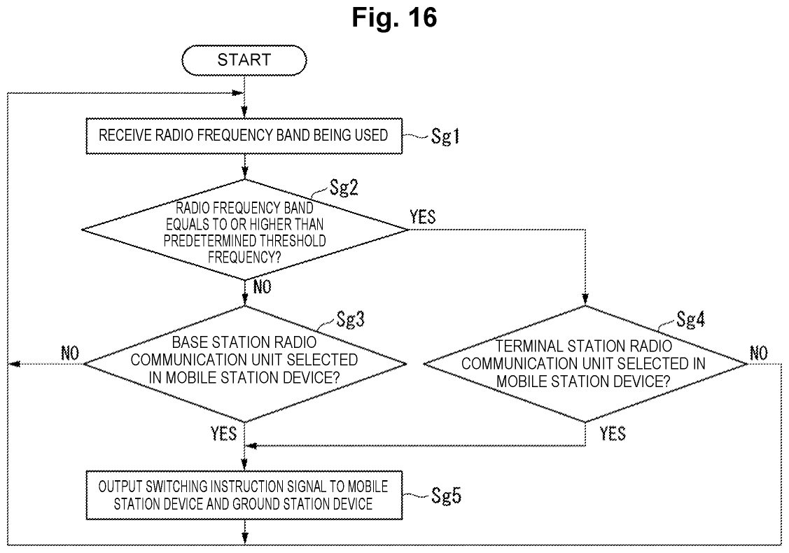

Next, wireless connection processing in the wireless communication system 1g of the fifth embodiment will be described with reference to a flowchart illustrated in FIG. 16.

Assume that in the initial state, as illustrated in FIG. 15, the base station wireless communication processing unit 22 is being connected to the mobile station antenna 21 in the mobile station device 2a and the terminal station wireless communication processing unit 32-1 is being connected to the ground station antenna 31-1 and the bridge device 4 in the ground station device 3g-1. It should be noted that the other ground station devices 3g-2, 3g-3, . . . have the same configuration as the ground station device 3g-1, and each of the terminal station wireless communication processing units 32-2, 32-3, . . . is connected with the ground station antenna 31-2, 31-3, . . . and with the bridge device 4.

In addition, assume that the mobile station device 2a is being connected by radio with the ground station device 3g-1. The switching instruction device 6g has an internal storage region store selection state data indicating that the base station wireless communication processing unit 22 is being selected in the mobile station device 2a.

Each of the radio frequency band detection units 37-1, 37-2, . . . of the ground station devices 3g-1, 3g-2, . . . detects a radio frequency band that is being used with the mobile station device 2a, from the terminal station wireless communication processing unit 32-1, 32-2, . . . . Each of the radio frequency band detection units 37-1, 37-2, . . . transmits radio frequency band data indicating the detected radio frequency band to the switching instruction device 6g via the bridge device 4.

The switching instruction device 6g receives the radio frequency band data that is transmitted by each of the radio frequency band detection units 37-1, 37-2, . . . (step Sg1). The switching instruction device 6g determines whether a radio frequency band indicated by the received radio frequency band data is equal to or higher than a predetermined threshold frequency (step Sg2). It should be noted that it is assumed that for the threshold value frequency, an appropriate frequency that allows a division into a high frequency band and a frequency band other than the high frequency band is predetermined. The threshold frequency is a frequency that is equal to or lower than a lower limit of the high frequency band. When the high frequency band is a frequency band including a quasi-millimeter wave band, a millimeter wave band, and a submillimeter wave band, the threshold frequency is, for example, 20 GHz. However, this threshold frequency is one example and when, for example, a high frequency band is a frequency band equal to or higher than the millimeter wave band, the threshold frequency is 30 GHz. The frequency band other than a high frequency band is a frequency band lower than the high frequency band.

When the radio frequency band is equal to or higher than a predetermined threshold frequency, the radio frequency can be considered as being in a high frequency band. When the radio frequency band is a high frequency band, a diffraction loss is large and a wireless connection is likely to broken due to an obstruction. Therefore, a configuration for performing a wireless connection equivalent to site diversity in the first embodiment is necessary.

On the other hand, when the radio frequency band is not equal to or higher than the predetermined threshold frequency, it can be considered as a frequency band other than a high frequency band. When the radio frequency band is a frequency band other than a high frequency band, a diffraction loss is small and the probability of causing a wireless connection to be broken due to an obstruction becomes smaller than that in the case of a high frequency band. Thus, configuration for performing a wireless connection through handover suffices.

Therefore, if determining that the radio frequency band is equal to or higher than a predetermined threshold frequency (step Sg2: Yes), the switching instruction device 6g advances processing to step Sg4 so as to configure the wireless communication system 1g to perform a wireless connection equivalent to site diversity in the first embodiment.

On the other hand, if determining that the radio frequency band is not equal to or higher than the predetermined threshold frequency (step Se2: Yes), the switching instruction device 6g advances processing to step Sg3 so as to configure the wireless communication system 1g to perform a wireless connection through handover.

In steps Sg3, Sg4, and Sg5, the same processing as in the steps Sa3, Sa4, and Sa5 illustrated in FIG. 4 is performed by the switching instruction device 6g.

Thus, in the wireless communication system 1g, it is possible to identify the characteristic of a radio propagation environment, based on the radio frequency band that is being used between the mobile station device 2a and the ground station devices 3g-1, 3g-2, . . . . In addition, it becomes possible to adaptively switch between configuring the wireless communication system 1g to perform wireless connection processing equivalent to site diversity and configuring the wireless communication system 1g to perform wireless connection processing through handover, according to the identified characteristic.

It should be noted that a technique for detecting the radio frequency band is not limited to the technique described for the wireless communication system 1g and any technique may be applied. For example, instead of providing the radio frequency band detection units 37-1, 37-2, . . . , data on the radio frequency band that is being used by the terminal station wireless communication processing unit 32-1, 32-2, . . . and base station wireless communication processing unit 33-1, 33-2, . . . of the ground station devices 3g-1, 3g-2, . . . may be directly transmitted to the switching instruction device 6g.

In the second to seventh embodiments described above, each of the switching instruction devices 6, 6b, 6d, 6e, 6f, and 6g transmits a switching instruction signal to the mobile station side switching unit 24 and the ground station side switching units 34-1, 34-2, . . . , thereby performing switching between the base station wireless communication processing unit 22 and the terminal station wireless communication processing unit 23 and switching between the terminal station wireless communication processing units 32-1, 32-2, . . . and the base station wireless communication processing units 33-1, 33-2, . . . . However, the configuration of the present invention is not limited to those embodiments. For example, the mobile station side switching unit 24 may include the configuration of the switching instruction device 6, 6b, 6d, 6e, 6f, or 6g so as to provide data indicating the characteristic of a radio propagation environment to the mobile station side switching unit 24; and perform switching between the base station wireless communication processing unit 22 and the terminal station wireless communication processing unit 23 without receiving a switching instruction signal from the switching instruction device 6, 6b, 6d, 6e, 6f, or 6g. Similarly, each of the ground station side switching units 34-1, 34-2, . . . may include the configuration of the switching instruction device 6, 6b, 6d, 6e, 6f, or 6g so as to provide data indicating the characteristic of a radio propagation environment to each of the ground station side switching units 34-1, 34-2, . . . ; and perform switching between the base station wireless communication processing unit 22 and the terminal station wireless communication processing unit 23 without receiving a switching instruction signal from the switching instruction device 6, 6b, 6d, 6e, 6f, or 6g. When both the mobile station side switching unit 24 and each of the ground station side switching units 34-1, 34-2, . . . include the configuration of the switching instruction device 6, 6b, 6d, 6e, 6f, or 6g, the wireless communication systems 1a, 1b, 1c, 1d, 1e, 1f, and 1g do not need to include the switching instruction device 6, 6b, 6d, 6e, 6f, or 6g.

In addition, in the third to seventh embodiments described above, specific examples of the characteristic of a radio propagation environment described in the second embodiment are described; however, these specific examples are merely examples. As long as the characteristic of a radio propagation environment is such that it is possible to determine that a fixed configuration in which the mobile station device 2 is for a base station side and the ground station devices 3-1, 3-2, . . . are for a terminal station side is not appropriate as described for the first embodiment, any characteristic can be used.

In addition, in the second to seventh embodiments described above, selection state data indicating whether the base station wireless communication processing unit 22 is being selected or the terminal station wireless communication processing unit 23 is being selected in the mobile station device 2a or 2b is stored in an internal storage region of the switching instruction device 6, 6b, 6d, 6e, 6f, or 6g. However, in the second to seventh embodiments described above, a selection state on the side of the ground station device 3-1, 3a-1, 3c-1, 3e-1, 3g-1, 3-2, 3a-2, 3c-2, 3e-2, 3g-2, . . . may be stored. Alternatively, the mobile station side switching unit 24 or the ground station side switching unit 34-1, 34-2, . . . may receive a request from the switching instruction device 6, 6b, 6d, 6e, 6f, or 6g, detect which of the function units is being connected to the mobile station antenna 21 or the ground station antenna 31-1, 31-2, . . . , generate selection state data, and notify the switching instruction device 6, 6b, 6d, 6e, 6f, or 6g of the generated selection state data.

Furthermore, in the descriptions of processing in the second to seventh embodiments, the configuration in an initial state has been described as a configuration for performing a wireless connection equivalent to site diversity; however, if the configuration in an initial state is a configuration for performing a wireless connection through handover, the same effect can be obtained. More specifically, the processing of adaptively switching between a configuration for performing wireless connection processing equivalent to site diversity and a configuration for performing wireless connection processing through handover is performed according to the characteristic of a radio propagation environment.

Still furthermore, the band of radio waves used in the wireless communication systems 1, 1a, 1b, 1c, 1d, 1e, and 1f of the first to sixth embodiments is a high frequency band; and in the wireless communication system 1g of the seventh embodiment, whether it is a high frequency band is determined with reference to a threshold frequency and in the case of a high frequency band, wireless connection processing equivalent to site diversity is performed. However, a configuration in which the mobile station device 2, 2a, or 2b is for a base station and the ground station device 3-1, 3a-1, 3c-1, 3e-1, 3g-1, 3-2, 3a-2, 3c-2, 3e-2, 3g-2, . . . is operated as a terminal station is applicable irrespective of a frequency band; and by being used in a frequency band other than a high frequency band, a wireless connection equivalent to site diversity can be realized even in a case where only a handover technique is provided.

Still furthermore, in the processing of the steps Sd2, Se2, Sf2, and Sg2 in the fourth to seventh embodiments described above, determination processing using an inequality sign or an inequality sign with a equality sign is performed. However, the present invention is not limited to those embodiments; and the determination processing based on “being equal to or more” or “being equal to or less” is merely one example and may be replaced with the determination processing based on “being over” or “being below” according to a manner of defining a threshold. Also for a threshold used in the determination processing, one example is described and a different threshold may be applied for each.

The mobile station devices 2, 2a, and 2b, the ground station devices 3-1, 3a-1, 3c-1, 3e-1, 3g-1, 3-2, 3a-2, 3c-2, 3e-2, 3g-2, . . . , the switching instruction devices 6, 6b, 6d, 6e, 6f, and 6g, the location estimation device 7, the velocity estimation device 8, the mobile station number calculation device 10, and the obstruction detection processing device 9 in the first to seventh embodiments described above may be implemented by a computer. In this case, an implementation may be performed by recording a program for implementing this function to a computer-readable recording medium, loading the program recorded in this recording medium into a computer system, and executing it. It should be noted that the “computer system” mentioned here includes an OS and hardware such as peripheral devices. In addition, the “computer readable recording medium” refers to a portable medium such as a flexible disk, a magneto-optical disk, a ROM, or a CD-ROM, or a storage device such as a hard disk built into the computer system. Further, the “computer readable recording medium” also may include one that dynamically holds a program for a short period of time, such as a communication line in the case of transmitting a program via a network such as the Internet or a communication line such as a telephone line, and one that holds a program for a given period of time, such as a volatile memory in a computer system serving as a server or client in that case. The above program may be for implementing a part of the above function, or may be one capable of implementing the above function in combination with a program already recorded in the computer system; or may be implemented using a programmable logic device such as a field programmable gate array (FPGA).

Although the embodiments of the present invention have been described above in detail with reference to the drawings, specific configurations are not limited to the embodiments, and a design and the like without departing from the gist of the present invention may also be included.

### INDUSTRIAL APPLICABILITY

The present invention is applicable to a wireless communication system that does not includes a site diversity function such as in IEEE802.11ad.

### REFERENCE SIGNS LIST

1 Wireless communication system
2 Mobile station device
3-1, 3-2 Ground station device
4 Bridge device
5 Communication network
21 Mobile station antenna
22 Base station wireless communication processing unit
31-1, 31-2 Ground station antenna
32-1, 32-2 Terminal station wireless communication processing unit

1. A wireless communication system comprising:
a plurality of ground station devices, each including a terminal station wireless communication processing unit that performs wireless communication processing for a side of a terminal station;
a single or a plurality of mobile station devices, each including a base station wireless communication processing unit that performs wireless communication processing for a side of a base station, the base station making a wireless connection in parallel with the terminal station, and makes a wireless connection in parallel with a plurality of the ground station devices having a line of sight; and
a bridge device that is connected with each of a plurality of the ground station devices and a communication network, and is configured to:
obtain connection configuration data from the ground station devices, the connection configuration data indicating a connection configuration between each of the ground station devices and the mobile station devices;
transfer, upon receipt of data whose transmission destination is any of the mobile station devices from the communication network, the received data to any of the ground station devices based on the obtained connection configuration data; and
send out, upon receipt of data from the ground station devices, the received data to the communication network.

2. The wireless communication system according to claim 1,
wherein
each of the mobile station devices includes:
the terminal station wireless communication processing unit; and
a mobile station side switching unit that switches between using the base station wireless communication processing unit and the terminal station wireless communication processing unit, according to a characteristic of a radio propagation environment; and
each of the ground station devices includes:
the base station wireless communication processing unit; and
a ground station side switching unit that performs switching according to the characteristic of the radio propagation environment, the switching being performed so that when the base station wireless communication processing unit is in use in the mobile station device, the terminal station wireless communication processing unit is used and when the terminal station wireless communication processing unit is in use in the mobile station device, the base station wireless communication processing unit is used.

3. The wireless communication system according to claim 2,
wherein
the characteristic of the radio propagation environment is a location of the mobile station device.

4. The wireless communication system according to claim 2,
wherein
the characteristic of the radio propagation environment is a velocity of the mobile station device in motion.

5. The wireless communication system according to claim 2,
wherein
the characteristic of the radio propagation environment is a number of the mobile station devices being connected to the ground station device.

6. The wireless communication system according to claim 2,
wherein
the characteristic of the radio propagation environment is a line-of-sight state between the mobile station device and the ground station device.

7. The wireless communication system according to claim 2,
wherein
the characteristic of the radio propagation environment is a radio frequency band used by the mobile station device and the ground station device.

8. A wireless connection method, comprising:
causing a plurality of ground station devices to perform wireless communication processing for a side of a terminal station;
causing a single or a plurality of mobile station devices to perform wireless communication processing for a side of a base station, the base station making a wireless connection in parallel with the terminal station, so as to make a wireless connection in parallel with a plurality of the ground station devices having a line of sight; and
causing a bridge device to be connected with each of a plurality of the ground station devices and a communication network and to perform:
obtaining connection configuration data from the ground station devices, the connection configuration data indicating a connection configuration between each of the ground station devices and the mobile station devices;
transferring, upon receipt of data whose transmission destination is any of the mobile station devices from the communication network, the received data to any of the ground station devices based on the obtained connection configuration data; and
sending out, upon receipt of data from the ground station devices, the received data to the communication network.
